(19) United States
(12) Patent Application Publication
(10) Pub. No.: US 2026/0230569 A1
(43) Pub. Date: Aug. 6, 2026

(54) STORAGE MEDIUM STORING APPLICATION PROGRAM THAT MAKES IT POSSIBLE TO LAY OUT IMAGES ON PLURALITY OF PAGES IN ONE PAGE, METHOD, AND INFORMATION PROCESSING APPARATUS

(71) Applicant: CANON KABUSHIKI KAISHA, Tokyo (JP)

(72) Inventor: KIMIMORI EGUCHI, Chiba (JP)

(21) Appl. No.: 19/462,394

(22) Filed: Jan. 28, 2026

(30) Foreign Application Priority Data
Feb. 5, 2025 (JP) 2025-017797

(51) Int. Cl. H04N 1/00; H04N 1/203

(52) U.S. Cl. CPC H04N 1/00482; H04N 1/2038

(57) ABSTRACT

A non-transitory computer-readable storage medium storing an application program causing a computer to execute a method. The method includes supporting a standard driver provided from a provider of an operating system, and displaying a screen for receiving settings related to layout processing for laying out respective images on a plurality of pages in one page, which have been acquired by causing an image processing apparatus to read originals using the standard driver.

### BACKGROUND

### Field of the Technology

The present disclosure relates to a storage medium storing an application program that makes it possible to lay out images on a plurality of pages in one page, a method, and an information processing apparatus.

### Description of the Related Art

There is known a configuration that uses a scan driver installed in an information processing apparatus as software for controlling an image processing apparatus (including a scanning device) and provides an instruction for scanning (reading) an original to an image processing apparatus connected to the information processing apparatus. In the information processing apparatus, an operating system (OS) as basic software has been installed, and the scan driver is configured according to specifications defined by the OS and operates when called from this OS. On the other hand, by providing a scan driver conforming to specifications of an OS, a maker that provides an image processing apparatus can provide means for instructing the image processing apparatus to read an original by using this OS. Note that in the present disclosure, the maker includes a vendor of an image processing apparatus.

Incidentally, in recent years, in Windows (registered trademark), a standard class driver (hereinafter sometimes referred to as the “standard driver”) is provided, which can be commonly used for image processing apparatuses supplied from a plurality of makers, respectively. The standard driver is packaged in the OS package and can easily become available by connecting a desired image processing apparatus to a host computer. Therefore, if the standard driver is provided, a user is not required to install a model-specific scan driver suitable for an image processing apparatus, and hence the convenience of the standard driver is high. Further, the standard driver is assumed to be configured to be capable of making settings of a scan function according to scan function information generated based on information acquired from a connected image processing apparatus. This enables a user to make settings of a scan function according to the capabilities of the connected image processing apparatus, in spite of using only one standard driver.

However, the scan functions which can be set by a user are limited to functions which can be realized only by the standard driver, and hence the user cannot make settings of an original function of a maker. As a technique related to this point, Japanese Laid-Open Patent Publication (Kokai) No. 2009-100018 discloses a reduced layout function that scans and reads a plurality of pages of originals, consolidates and arranges the plurality of pages of originals into one page, and outputs the image data of one page.

In this point, the scan functions supported by a scan driver unique to a maker also include, as a similar function, a function that performs processing for laying out respective images on a plurality of pages, acquired by reading originals, into one page. This processing is processing for laying out, when a size of one page after laying out images is set to a desired size, respective images on a plurality of pages, acquired by reading originals, such that the images are fit in the set size (after being reduced/enlarged in some cases). However, there is a problem that in a case where an original is read by using the standard driver, settings of the function for performing the above-described processing cannot be made, and hence it is impossible to provide this function to a user.

### SUMMARY

The present disclosure is directed to providing an application program that makes it possible to lay out respective images on a plurality of pages, acquired by reading originals using a standard driver, in one page, a storage medium, a method, and an information processing apparatus.

In a first aspect of the present disclosure, there is provided a non-transitory computer-readable storage medium storing an application program causing a computer to execute a method, the method including supporting a standard driver provided from a provider of an operating system, and displaying a screen for receiving settings related to layout processing for laying out, in one page, respective images on a plurality of pages, which have been acquired by causing an image processing apparatus to read originals by using the standard driver.

In a second aspect of the present disclosure, there is provided a method performed by an information processing apparatus that executes an application program supporting a standard driver provided from a provider of an operating system, including causing the application program to display a screen for receiving settings related to layout processing for laying out respective images on a plurality of pages in one page, which have been acquired by causing an image processing apparatus to read originals by using the standard driver.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a scan system.

FIGS. 2A and 2B are block diagrams each showing a software configuration of the scan system in a first embodiment.

FIGS. 3A to 3F are diagrams showing examples of a scan setting screen and detailed setting screens.

FIGS. 4-1 to 4-7 are image diagrams useful in explaining 2-in-1 processing.

FIG. 5 is a flowchart of a process performed, in the first embodiment, by a scan function-extending unit of an extension application, for editing scan function information.

FIG. 6 is a diagram showing examples of respective lists of capabilities information acquired from a scanning device, scan functions supported by the extension application, and the scan function information generated by general-purpose scan software.

FIG. 7 is a sequence diagram showing a scan process executed, in the first embodiment, by a scan application, the general-purpose scan software, the extension application, and the scanning device.

FIG. 8 is a flowchart of a process performed by the extension application in the sequence diagram in FIG. 7.

FIG. 9 is a flowchart of a process performed by the scanning device in the sequence diagram in FIG. 7.

FIG. 10 is a flowchart of the 2-in-1 processing.

FIGS. 11-1 to 11-5 are image diagrams useful in explaining a carrier sheet mode and a license mode.

FIG. 12 is a diagram showing a software configuration of the scan system in a case where the extension application is associated with the general-purpose scan software and the scanning device, in a second embodiment.

FIG. 13 is a diagram showing examples of respective lists of the capabilities information acquired from the scanning device, the scan functions supported by the extension application, and the scan function information generated by the general-purpose scan software, in the second embodiment.

FIG. 14 is a flowchart of a process executed, in the second embodiment, by the scan function-extending unit of the extension application, for editing the scan function information.

FIG. 15 is a sequence diagram showing a scan process executed, in the second embodiment, by the scan application, the general-purpose scan software, the extension application, and the scanning device.

FIG. 16 is a sequence diagram showing a scan process executed, in a third embodiment, by the scan application, the general-purpose scan software, the extension application, and the scanning device.

FIGS. 17A and 17B are diagrams each showing an example of a UI screen displayed when an original is placed on an original platen glass.

FIGS. 18-1 to 18-6 are image diagrams useful in explaining a business card/invoice mode and a book mode.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configurations of the present disclosure can be replaced with desired components which can exhibit the same functions. Further, desired components can be added. Further, two or more desired components (features) of the embodiments can be combined. Note that the same component/processing is denoted by the same reference numeral, and description thereof is omitted.

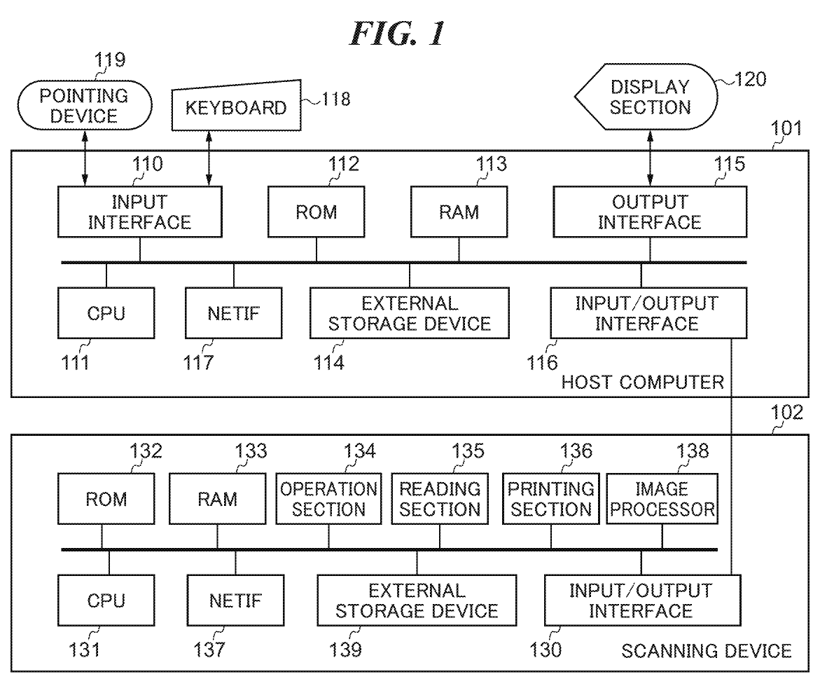

A first embodiment will be described below with reference to FIGS. 1 to 10. Here, a description will be given of processing for causing, by an extension application associated with a standard driver, a central processing unit (CPU) of a host computer to execute processing for laying out respective images on a plurality of pages, which are acquired by causing a scanning device to read originals by using the standard driver, into one page. That is, layout processing performed in the first embodiment will be described. Note that in the first embodiment, the above-mentioned plurality of pages are two pages. The layout processing in this case is hereinafter referred to as the 2-in-1 processing. Further, note that in the first embodiment, reading of an original is performed on a feeder of the scanning device.

FIG. 1 is a block diagram showing a hardware configuration of a scan system. As shown in FIG. 1, the scan system includes a host computer 101 and a scanning device 102. The host computer 101 (information processing apparatus) can be a desktop-type personal computer, a smartphone, a laptop-type personal computer, or a tablet terminal. Referring to FIG. 1, the host computer 101 includes an input interface 110, a CPU 111 (computer), a read only memory (ROM) 112, a random access memory (RAM) 113, an external storage device 114, an output interface 115, an input/output interface 116, and a network (NET) interface 117. Further, to the input interface 110, input devices, such as a keyboard 118 and a pointing device 119, are connected, and to the output interface 115, a display device, such as a display section 120, is connected.

On the display section 120, for example, a scan setting screen and a detailed setting screen, described hereinafter, are displayed. The NET interface 117 is a network interface and performs control to transfer data to and from an external apparatus via a network. In the ROM 112, an initialization program is stored. The external storage device is, for example, a hard disk drive (HDD) or a solid state drive (SSD). In the external storage device 114, an application program group, an operating system (OS), and a variety of other data items are stored. The RAM 113 is used e.g. as a work memory when a variety of programs stored in the external storage device 114 are executed. With this, the variety of programs can operate in the host computer 101. Note that in the first embodiment, the CPU 111 performs processes according to program codes stored in the ROM 112 or program codes stored in the external storage device 114. With this, functions, described hereinafter, of the host computer 101, and processes of flowcharts and sequences, described hereinafter, are executed.

To the host computer 101, the scanning device 102 is connected via the input/output interface 116. The scanning device 102 includes an input/output interface 130, a CPU 131, a ROM 132, a RAM 133, an operation section 134, a reading section 135, a printing section 136, a NET interface 137, an image processor 138, and an external storage device 139. To the input/output interface 130, the input/output interface 116 of the host computer 101 is connected. The input/output interface 130 of the scanning device 102 and the input/output interface 116 of the host computer 101 can be connected by a wired network or can be connected by a wireless network, to each other.

The CPU 131 is configured to perform centralized control of the scanning device 102. The ROM 132 is a memory storing programs and the like. The RAM 133 provides a memory for temporarily storing a program and image data when the program is executed by the CPU 131. The reading section 135 is a scanner and acquires image data by reading an image from an original. The printing section 136 prints an image on a sheet based on image data. Note that the printing section 136 can be omitted. The NET interface 137 is a network interface and performs control to transfer data to and from an external apparatus via a network. The image processor 138 performs various types of image edit processing operations on the image data input thereto.

The external storage device 139 is e.g. an HDD or SSD. The external storage device 139 stores programs, image data, and so forth. Note that in the first embodiment, the scanning device 102 will be described as an example of an image processing apparatus. The scanning device 102 is an electrophotographic digital multifunction peripheral having not only a function of reading an original, but also a plurality of functions, such as copy, print, and FAX functions. However, the image processing apparatus is not limited to this but can be e.g. a multifunction peripheral using another process based on an inkjet method, or a scanner having only the function of reading an original. Further, although in the first embodiment, the host computer 101 and the scanning device 102 are separately configured, these can be configured as one information processing apparatus.

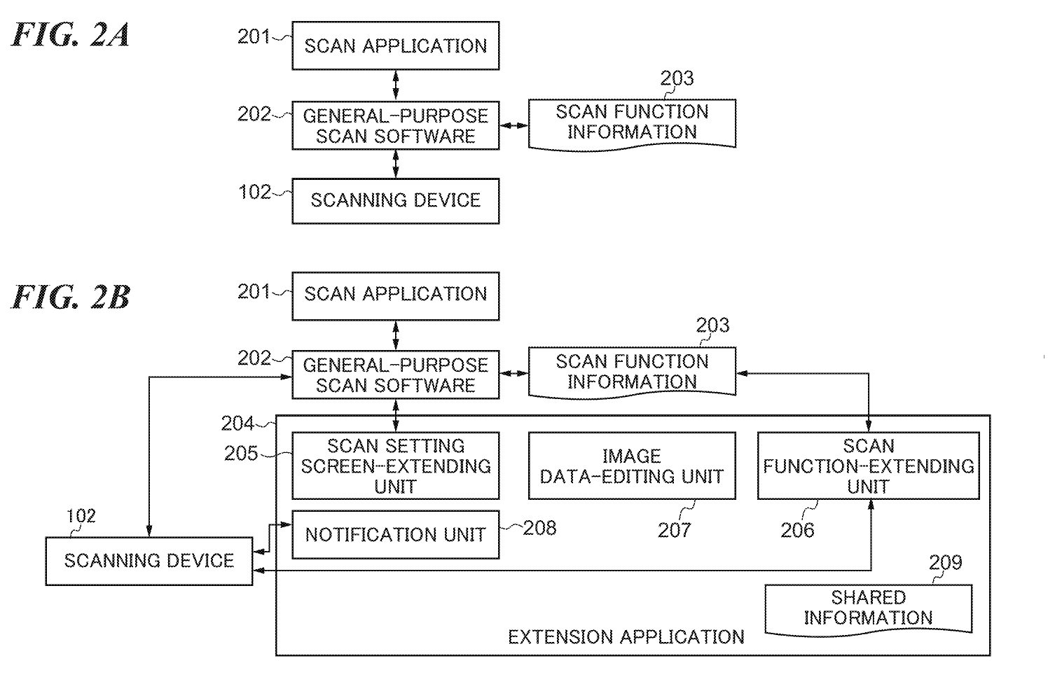

FIGS. 2A and 2B are block diagrams each showing a software configuration of the scan system. Here, the scan system using the host computer 101 which has installed Windows (registered trademark) 11 of Microsoft (registered trademark) as the OS is assumed and described. FIG. 2A shows, as a general configuration of the software configuration of the scan system, a scan application 201, general-purpose scan software 202 (standard driver), and scan function information 203. FIG. 2B shows an extension application 204 (application program) in addition to the general configuration of the software configuration of the scan system, shown in FIG. 2A.

That is, FIG. 2A is a diagram showing a general configuration in a case where the extension application 204 is not associated with general-purpose scan software 202 and the scanning device 102. On the other hand, FIG. 2B is a diagram showing a configuration in a case where the extension application 204 is associated with the general-purpose scan software 202 and the scanning device 102. Note that the software configuration shown in each of FIGS. 2A and 2B is stored in the external storage device 114 of the host computer 101.

First, referring to FIG. 2A, a configuration will be described of the scan system in the case where the extension application 204 is not associated with general-purpose scan software 202 and the scanning device 102. FIG. 2A shows, as components of the general configuration of the software configuration of the scan system, the scan application 201, the general-purpose scan software 202, and the scan function information 203. The scan application 201 is software for taking in contents (image data) generated by reading an original. For example, a document creation application and an image editing application correspond to the scan application 201. The scan application 201 issues a scan instruction to the OS upon receipt of a scan request from a user. The scan instruction includes scan setting information for instructing operations of the general-purpose scan software 202 and the scanning device 102.

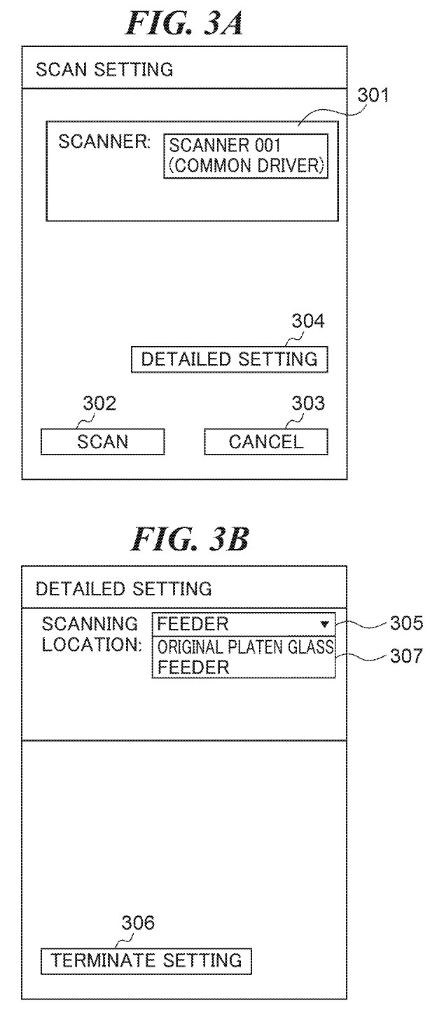

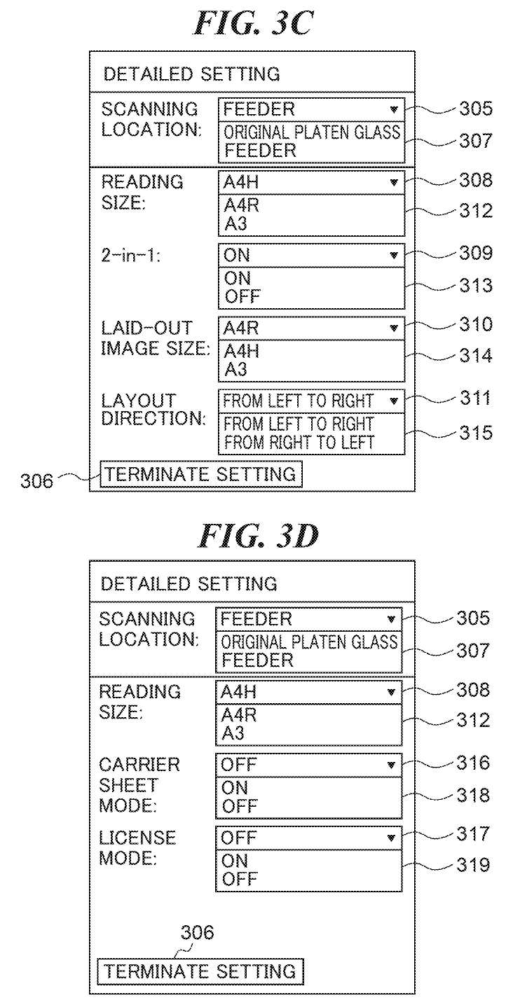

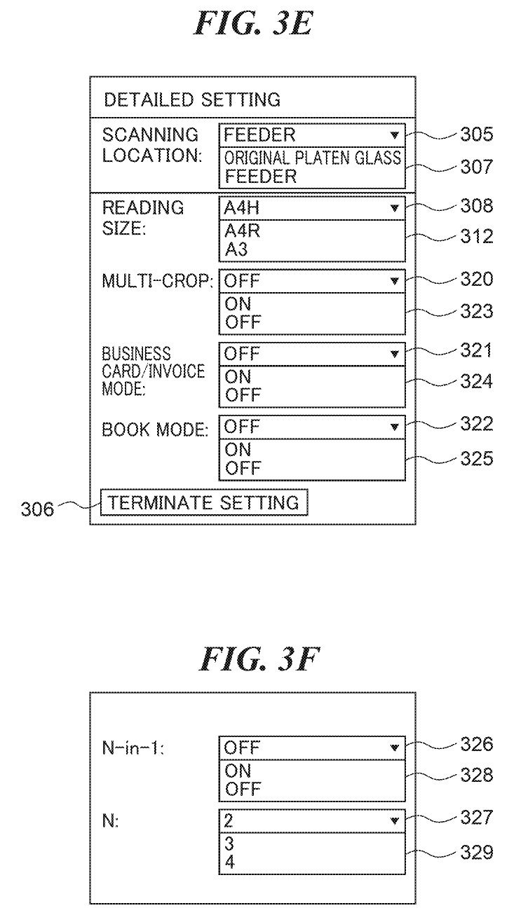

To issue a scan instruction, the scan application 201 can display the scan setting screen provided by one of the general-purpose scan software 202, the OS, and the scan application 201. Further, when a detailed setting button in the scan setting screen is selected, the general-purpose scan software 202 additionally displays the detailed setting screen. Details of the scan setting screen and the detailed setting screen will be described hereinafter with reference to FIGS. 3A to 3F. The detailed setting screen includes setting items (hereinafter referred to as the “control items”) with which a user can make settings of a scan function and control items indicating settings of the setting items, which are displayed according to capabilities information (information which can be set) of the general-purpose scan software 202.

The general-purpose scan software 202 determines scan capabilities based on the scan function information 203. The scan function information 203 is data indicating scan functions, in which are described all scan functions which can be set by a user, settings of these scan functions, and an exclusive relation between settings. The scan function information 203 is included in a configuration file of the general-purpose scan software 202 and is stored in the external storage device 114 as an unchangeable file. Alternatively, the scan function information 203 can be dynamically generated e.g. by the general-purpose scan software 202. Specifically, the general-purpose scan software 202 or the OS can be configured to acquire attribute data of the scanning device 102 from the scanning device 102 and generate the scan function information 203 according to attribute information in the acquired attribute data. Note that in a case where the scan function information 203 is dynamically generated, the generated scan function information 203 can be edited.

Further, the attribute data of the scanning device 102 includes the attribute information indicating the functions (capabilities of the scanning device 102) of which settings can be made by a user, and settings related to the attribute information. This information is stored in the RAM 113. With this configuration, the general-purpose scan software 202 enables a user to make settings of a scan function which can be used in each of scanning devices connected to the host computer 101 according to the connected scanning device. That is, even in a case where a scanning device having a different function or a scanning device developed by a different vendor is connected, the general-purpose scan software 202 enables a user to make settings of a scan function which can be used according to the connected scanning device. Note that as described above, the maker can be the vendor of the scanning device.

Note that in the first embodiment, as the general-purpose scan software 202, a standard class driver that executes reading of an original based on a standard scan protocol called Mopria is used. The general-purpose scan software 202 acquires the capabilities information of the connected scanning device 102 and generates the scan function information 203 based on the acquired information so as to enable a user to make settings of a scan function supported by the connected scanning device 102. However, the general-purpose scan software 202 does not support e.g. a function of a reading size. This is because the function of the reading size is a function unique to a maker.

Next, the configuration of the scan system in the case where the extension application 204 is associated with the general-purpose scan software 202 and the scanning device 102 will be described with reference to FIG. 2B. FIG. 2B shows the extension application 204 in addition to the general configuration of the software configuration of the scan system, shown in FIG. 2A. Note that the components and processing which are not particularly mentioned are the same components and processing as in FIG. 2A. The extension application 204 is software for supporting the function of the general-purpose scan software 202 and not included (packaged) in the OS in advance.

Therefore, the user is required to download and install the extension application 204 from a server into the host computer 101 via the Internet by operating the host computer 101. Alternatively, when the scanning device 102 is connected to the host computer 101, the extension application 204 can be automatically installed into the host computer 101 according to this connection. Specifically, in a case where the scanning device 102 is connected to the host computer 101, the OS acquires device identification information from the scanning device 102. Further, the OS downloads the extension application 204 associated with this device identification information from the server via the Internet and installs the downloaded extension application 204 into the host computer 101. That is, the general-purpose scan software 202 and the extension application 204 are held in the host computer 101 as separate files. Note that by the CPU 111 of the host computer 101 reading the extension application 204 stored in a storage medium, the extension application 204 can be installed into the host computer 101.

Note that the general-purpose scan software 202 and the extension application 204 are sometimes updated and their versions are upgraded, but this update processing is performed at respective separate timings. That is, the timing at which the general-purpose scan software 202 is acquired by the host computer 101 and the timing at which the extension application 204 is acquired by the host computer 101 are different. Further, a trigger with which the general-purpose scan software 202 is acquired by the host computer 101 and a trigger with which the extension application 204 is acquired by the host computer 101 are also different. Note that in a case where the extension application 204 has been installed, the OS associates the extension application 204 with the general-purpose scan software 202 and the scanning device 102.

As shown in FIG. 2B, the extension application 204 includes a scan setting screen-extending unit 205, a scan function-extending unit 206, an image data-editing unit 207, and a notification unit 208. Further, the extension application 204 includes shared information 209 which can be commonly accessed from each unit. The shared information 209 is a file stored in the external storage device 114 or information stored in the RAM 113 of the host computer 101. The extension application 204 writes and reads information into and from the shared information 209 by using an application program interface (API) provided by the OS. Note that the extension application 204 can terminate the operation whenever processing executed by each unit is terminated. In this case, the OS starts the extension application 204 whenever a request for using each unit is received. Further, while the processing is being performed by each unit, the extension application 204 can cancel this processing. In a case where the extension application 204 cancels the processing, a job being processed is deleted by the OS.

Upon receipt of a scan request from a user, the scan application 201 issues a scan instruction to the OS. Similar to the configuration shown in FIG. 2A, even in the configuration shown in FIG. 2B, the scan application 201 can also display the scan setting screen. Further, in the configuration shown in FIG. 2B, when a detailed setting button in the scan setting screen is selected, a detailed setting screen provided by the extension application 204 is additionally displayed. Specifically, a detailed setting screen provided by the scan setting screen-extending unit 205 of the extension application 204 is displayed. The detailed setting screen provided by the scan setting screen-extending unit 205 of the extension application 204 includes control items with which a user can make settings of a scan function and control items indicating settings of the functions. Further, the scan setting screen-extending unit 205 can store a function set by the user and settings of the function made by the user, on the detailed setting screen, in the shared information 209, as the detailed setting information.

The image data-editing unit 207 acquires image data from the scanning device 102 and edits the acquired image data. The image data-editing unit 207 acquires detailed setting information from the shared information 209 and performs image editing on the image data according to the settings included in the acquired detailed setting information. Note that the extension application 204 can acquire the image data via the general-purpose scan software 202 and perform image editing on the acquired image data according to the settings included in the detailed setting information. Further, also in the configuration shown in FIG. 2B, there is a case where a setting of the reading size, described hereinafter, or the like is not made by the user. In this case, the general-purpose scan software 202 can transmit a scan instruction to the scanning device 102 without using the extension application 204 as in the configuration shown in FIG. 2A.

The scan function-extending unit 206 can edit the scan function information 203 generated by the general-purpose scan software 202 or the OS. With this, the scan function-extending unit 206 can add a function provided by the extension application 204. Further, the scan function-extending unit 206 can add a function which is supported by the scanning device 102 but not supported by the general-purpose scan software 202 (such as the function of the reading size) and add an exclusive relationship between settings of the scan function. The OS starts the scan function-extending unit 206 when the extension application 204 is associated with the scanning device 102 and the general-purpose scan software 202 for the first time. Further, the OS can start the scan function-extending unit 206 at a timing other than this (such as a timing when the OS is started).

The notification unit 208 can display, when an error of the scanning device 102 occurs, a notification to a user. For example, if a reading jam error has occurred in the scanning device 102, the general-purpose scan software 202 detects occurrence of this error, and the OS displays a message on the display section 120 by using a notification function referred to as the toast notification which is one of the functions of the OS. When the user selects this toast notification by using e.g. the pointing device 119, the notification unit 208 is called by the OS, and a UI screen of the notification unit 208 is displayed. The notification 208 can display a detailed message concerning the reading jam error, a jam resolving method, and so forth, on the UI screen.

Note that the configuration of the extension application 204 is not limited to the configuration having all the above-described functions (units), but the extension application 204 can be configured to have some of them or have another function. Further, the extension application 204 is sometimes simply referred to as the scan software. As described above, it can be said that the extension application 204 has at least one of the following functions: The first function is the function of displaying a detailed setting screen (the scan setting screen-extending unit 205). The second function is the function of editing image data according to settings on the detailed setting screen (the image data-editing unit 207). The third function is the function of supporting the function of the general-purpose scan software 202 (the scan function-extending unit 206). The fourth function is the function of displaying the UI screen in response to occurrence of an error in the scanning device 102 (the notification unit 208). Note that the scan application 201, the general-purpose scan software 202, and the extension application 204 are started when read out from the external storage device 114, loaded into the RAM 113, and executed by the CPU 111.

Next, examples of the scan setting screen and the detailed setting screen will be described with reference to FIGS. 3A to 3F. FIG. 3A shows the scan setting screen displayed by the scan application 201. FIG. 3B shows the detailed setting screen displayed in the case of the configuration shown in FIG. 2A, i.e. the configuration in which the extension application 204 is not associated. FIG. 3C shows the detailed setting screen displayed in the case of the configuration shown in FIG. 2B, i.e. the configuration in which the extension application 204 is associated. Note that a unit or module that displays the scan setting screen is not limited to the above-mentioned ones. For example, the scan setting screen-extending unit 205 can be configured only to generate a display screen. In this case, the scan setting screen-extending unit 205 transmits the generated display screen to the scan application 201 via the general-purpose scan software 202. The scan application 201 displays the display screen thus acquired.

FIG. 3A shows the scan setting screen displayed by the scan application 201. First, the scan setting screen shown in FIG. 3A will be described. The scan setting screen shown in FIG. 3A is a UI screen having control items 301 to 304. The control item 301 has one or more setting items for causing a user to set a scanner (i.e. scanning device) used for reading an original. The control item 302 is a button for starting reading of an original. The control item 303 is a button for canceling reading of an original. The control item 304 is a detailed setting button. When the control item 304 is selected by using e.g. the pointing device 119, an additional detailed setting screen is displayed by the general-purpose scan software 202 or by the scan setting screen-extending unit 205.

FIG. 3B shows the detailed setting screen displayed by the general-purpose scan software 202. Next, the detailed setting screen shown in FIG. 3B will be described. The detailed setting screen shown in FIG. 3B is an additional detailed setting screen displayed by the general-purpose scan software 202 in the case where the extension application 204 is not associated. Further, the detailed setting screen shown in FIG. 3B is a UI screen having control items 305 and 306, and a list 307. The list 307 is one of the control items. This point is also applied to lists, described hereinafter. The control item 305 enables the user to set a scanning location, and FIG. 3B shows a state in which “feeder” is set.

When the control item 305 is selected by using e.g. the pointing device 119, the scanning locations which can be set by the control item 305 are indicated by the list 307. The list 307 indicates that the scanning locations which can be set by the control item 305 include not only “feeder”, currently set, but also “original platen glass”. The control item 306 is a button for terminating making settings. When the control item 306 is selected by using e.g. the pointing device 119, the detailed setting screen shown in FIG. 3B is closed, and the screen returns to the scan setting screen shown in FIG. 3A.

FIG. 3C shows the detailed setting screen displayed by the scan setting screen-extending unit 205. Next, the detailed setting screen shown in FIG. 3C will be described. The detailed setting screen shown in FIG. 3C is an additional detailed setting screen displayed by the scan setting screen-extending unit 205 in the case where the extension application 204 is associated. The detailed setting screen shown in FIG. 3C is a UI screen (first screen) formed by adding control items 308 to 311 and lists 312 to 315 to the detailed setting screen shown in FIG. 3B.

The control item 308 enables the user to set a reading size, and FIG. 3C shows a state in which “A4H” is set. When the control item 308 is selected by using e.g. the pointing device 119, the reading sizes which can be set by the control item 308 are indicated by the list 312. The list 312 indicates that the reading sizes which can be set by the control item 308 include not only “A4H”, currently set, but also “A4R” and “A3”. The user can change the reading size and perform reading of an original by selecting a desired reading size from the list 312 by using e.g. the pointing device 119.

The control item 309 enables the user to set whether or not to perform the 2-in-1 processing, and FIG. 3C shows a state in which “on” is set for the control item 309. When the control item 309 is selected by using e.g. the pointing device 119, the setting items which can be set by the control item 309 are indicated by the list 313. The list 313 indicates that the setting items which can be set by the control item 309 include not only “on”, currently set, but also “off”. The user can perform the 2-in-1 processing by selecting “on” from the list 313 by using e.g. the pointing device 119. Note that details of the 2-in-1 processing will be described hereinafter.

The control item 310 enables the user to set a size after laying out images (hereinafter referred to as the “laid-out image size” in an abbreviated form) in the 2-in-1 processing, and FIG. 3C shows a state in which “A4R” is set. When the control item 310 is selected by using e.g. the pointing device 119, the laid-out image sizes which can be set by the control item 310 are indicated by the list 314. The list 314 indicates that the laid-out image sizes which can be set by the control item 310 include not only “A4R”, currently set, but also “A4H” and “A3”.

The control item 311 enables the user to set a direction of laying out images (hereinafter referred to as the “layout direction” in an abbreviated form) in the 2-in-1 processing, and FIG. 3C shows a state in which “from left to right” is set. When the control item 311 is selected by using e.g. the pointing device 119, the layout directions which can be set by the control item 311 are indicated by the list 315. The list 315 indicates that the layout directions which can be set by the control item 311 include not only “from left to right”, currently set, but also “from right to left”.

Here, the 2-in-1 processing will be described. The 2-in-1 processing is processing for laying out respective images of two pages, acquired by reading original sheets using the general-purpose scan software 202, into one page. As described above, the user can set a reading size by the control item 308. Further, the user can set a laid-out image size by the control item 310 as the size of each of the laid-out images and set a layout direction by the control item 311 as the direction of laying out the images.

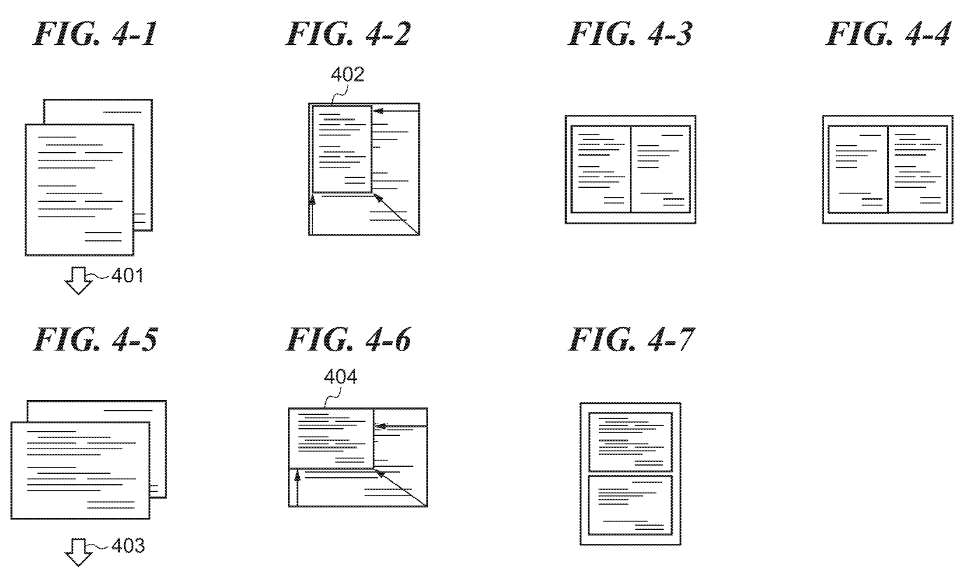

The 2-in-1 processing will be described below with reference to FIGS. 4-1 to 4-7. In the 2-in-1 processing, when the reading size is set to “A4H”, an original is read while being conveyed in a downward direction indicated by an arrow 401 in FIG. 4-1, i.e. in a direction along the long side of the original. Further, when the laid-out image size is set to “A4R”, an image acquired by reading an original is reduced to the A4R size as indicated by reference numeral 402 in FIG. 4-2. At this time, when the layout direction is set to “from left to right”, an image reduced in size after the first operation of reading an original is laid out in the left part, and an image reduced in size after the second operation of reading an original is laid out in the right part, as shown in FIG. 4-3. On the other hand, when the layout direction is set to “from right to left”, an image acquired by the first operation of reading an original is laid out in the right part, and an image acquired by the second operation of reading an original is laid out in the left part, as shown in FIG. 4-4.

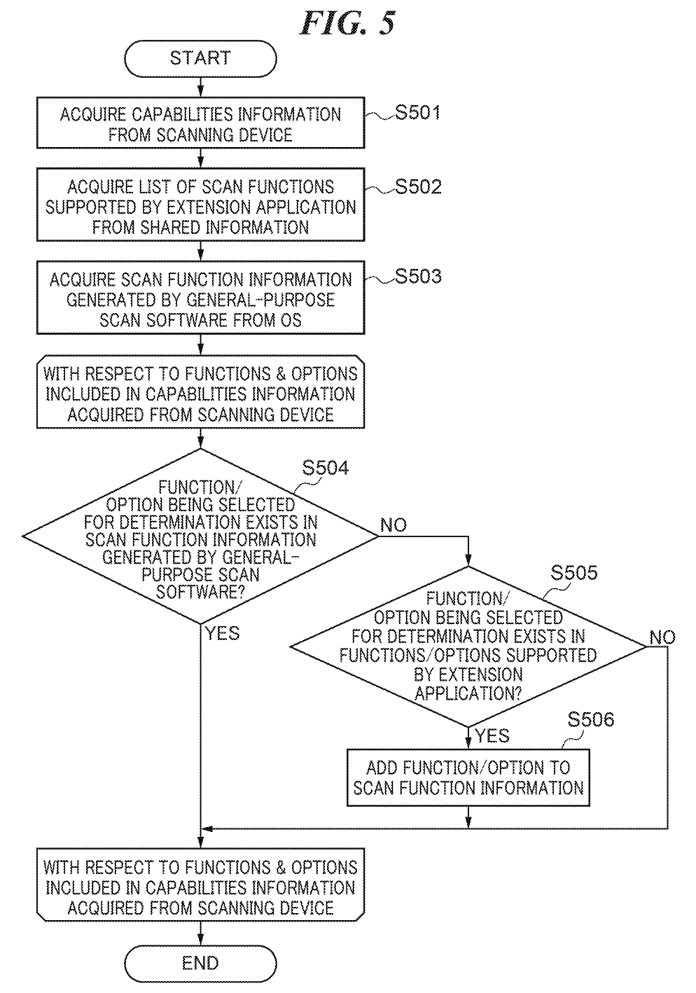

Note that when the reading size is set to “A4R”, an original is read while being conveyed in a downward direction indicated by an arrow 403 in FIG. 4-5, i.e. in a direction along the short side of the original. At this time, in a case where the set laid-out image size is the A4 size, the laid-out image size is fixed to “A4H”. Therefore, an image acquired by reading an original is reduced to the A4H size as indicated by reference numeral 404 in FIG. 4-6. Further, in this case, the layout direction is not set by the control item 311 or the list 315 but fixed to “from top to bottom”. Therefore, as shown in FIG. 4-7, an image reduced after being acquired by the first operation of reading an original is laid out in the upper part, and an image reduced after being acquired by the second operation of reading an original is laid out in the lower part. However, the layout direction can be fixed not to “from top to bottom” but to “from bottom to top”.

Here, a reason why the control items are different between the detailed setting screens shown in FIGS. 3B and 3C will be described. The detailed setting screen is generated by referring to the scan capabilities determined based on the scan function information 203. However, the general-purpose scan software 202 does not support the functions of the reading size, the 2-in-1 processing, the laid-out image size, and the layout direction, and hence these functions cannot be added to the scan function information 203. Further, even if the functions of the reading size, the 2-in-1 processing, the laid-out image size, and the layout direction are originally included in the scan function information 203, the general-purpose scan software 202 cannot interpret these functions.

For this reason, the general-purpose scan software 202 cannot display the control items 308 to 311, and so forth, which make it possible to make settings of the reading size, the 2-in-1 processing, the laid-out image size, and the layout direction, on the detailed setting screen. On the other hand, in a case where the extension application 204 is included, the scan function-extending unit 206 adds the functions of the reading size, the 2-in-1 processing, the laid-out image size, and the layout direction to the scan function information 203. Further, the scan setting screen-extending unit 205 displays the detailed setting screen generated by referring to the scan capabilities. As a result, the extension application 204 can display the control items 308 to 311, and so forth, which make it possible to make settings of the reading size, the 2-in-1 processing, the laid-out image size, and the layout direction, on the detailed setting screen. However, on the detailed setting screen shown in FIG. 3C, a control item or the like which makes it possible to make a setting other than the settings of the reading size, the 2-in-1 processing, the laid-out image size, and the layout direction can be additionally displayed. Note that FIGS. 3D to 3F will be described hereinafter.

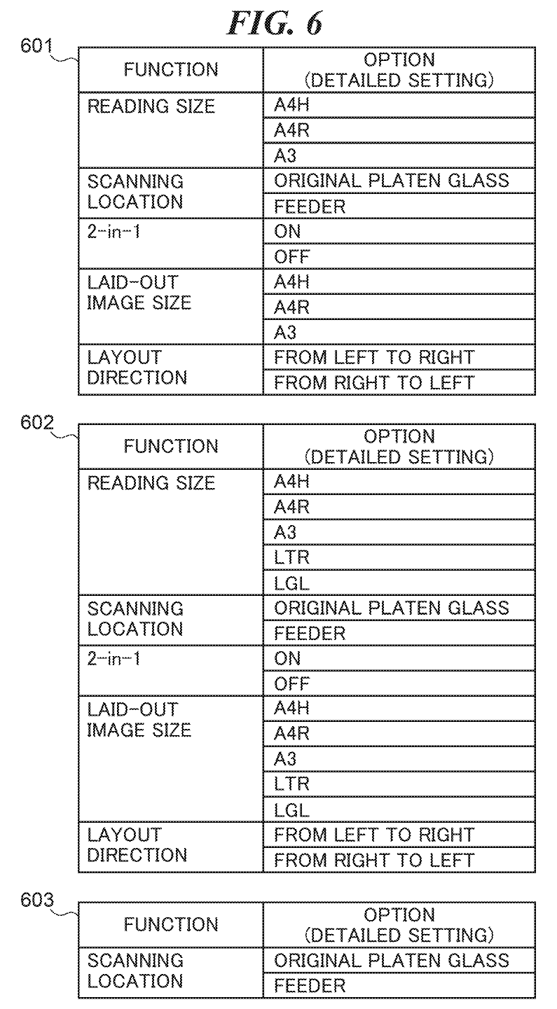

Here, a process performed by the scan function-extending unit 206 of the extension application 204 for editing the scan function information 203 will be described with reference to FIG. 5. Steps of the editing process in FIG. 5 are realized by the CPU 111 of the host computer 101 that executes the extension application 204 by loading the same read out from the external storage device 114 into the RAM 113. When the editing process in FIG. 5 is started, in a step S501, the CPU 111 controls the scan function-extending unit 206 to acquire the capabilities information from the scanning device 102. The capabilities information includes attribute information indicating the functions which can be set in the scanning device 102 and settings related to the attribute information. A table 601 shown in FIG. 6 shows an example of a list of the capabilities information acquired from the scanning device 102. As shown in the table 601, the functions of the reading size, the scanning location, and the like, and options which can be set for each function, can be acquired from the scanning device 102 as the capabilities information.

The description returns to the editing process in FIG. 5. Next, in a step S502, the CPU 111 controls the scan function-extending unit 206 to acquire a list of the scan functions supported by the extension application 204 from the shared information 209. The list of the scan functions supported by the extension application 204 describes all functions which can be processed by the extension application 204 and settings of these functions, and is stored in the shared information 209. A table 602 shown in FIG. 6 shows an example of a list of the scan functions supported by the extension application 204. Note that the list of the scan functions supported by the extension application 204 is sometimes updated e.g. by the update of the extension application 204.

The description returns to the editing process in FIG. 5. Then, in a step S503, the CPU 111 controls the scan function-extending unit 206 to acquire the scan function information 203 generated by the general-purpose scan software 202 from the OS. A table 603 shown in FIG. 6 shows an example of a list of the scan function information 203 generated by the general-purpose scan software 202. Note that the scan function information 203 generated by the general-purpose scan software 202 is generated based on the table 601 which is the list of the capabilities information acquired by the general-purpose scan software 202 from the scanning device 102. Further, the scan function information 203 generated by the general-purpose scan software 202 describes, out of the capabilities information acquired from the scanning device 102, only the functions supported by the general-purpose scan software 202 and settings of these functions.

Therefore, the functions of the scan function information 203 generated by the general-purpose scan software 202 are limitative. The table 601 which is the list of the capabilities information acquired from the scanning device 102 includes, for example, the function of the reading size. However, the general-purpose scan software 202 does not support the function of the reading size, and hence the function of the reading size is not described in the scan function information 203 generated by the general-purpose scan software 202. So, the scan function-extending unit 206 adds a function and options thereof to the scan function information 203, whereby the extension application 204 can compensate for shortage of functions of the general-purpose scan software 202. Further, the scan function-extending unit 206 is also capable of deleting an unnecessary function and options thereof from the scan function information 203 generated by the general-purpose scan software 202.

The description returns to the editing process in FIG. 5. The next steps S504, S505, and S506 are processing operations which are repeatedly executed on the functions and options included in the capabilities information acquired from the scanning device 102 in the step S501. That is, the steps S504, S505, and S506 are processing operations repeatedly executed on each of the twelve options included in the table 601, from “reading size: A4H” to “layout direction: from right to left”. First, in the step S504, the CPU 111 controls the scan function-extending unit 206 to determine whether or not a function and its option, being currently selected for determination, exist in the scan function information 203 generated by the general-purpose scan software 202.

If it is determined by the CPU 111 via the scan function-extending unit 206 that the function and its option, being currently selected for determination, exist in the scan function information 203 generated by the general-purpose scan software 202, the present process returns to the step S504. At this time, the CPU 111 controls the scan function-extending unit 206 to select a next item from the functions and options included in the capabilities information acquired from the scanning device 102 and execute the step S504 again. However, if the final item of the functions and options included in the capabilities information acquired from the scanning device 102 is being processed by the scan function-extending unit 206, the CPU 111 terminates the editing process in FIG. 5. On the other hand, if it is determined by the CPU 111 via the scan function-extending unit 206 that the function and its option, being currently selected for determination, do not exist in the scan function information 203 generated by the general-purpose scan software 202, the process proceeds to the step S505.

Specifically, for example, “scanning location: original platen glass” included in the table 601 which is the list of the capabilities information of the scanning device 102 is also included in the table 603 which is the list of the capabilities information of the general-purpose scan software 202. Therefore, in this case, it is determined by the CPU 111 via the scan function-extending unit 206 that the function and its option, being currently selected for determination, exist in the scan function information 203 generated by the general-purpose scan software 202. On the other hand, “reading size: A4H” included in the table 601 is not included in the table 603. Therefore, in this case, it is determined by the CPU 111 via the scan function-extending unit 206 that the function and its option, being currently selected for determination, do not exist in the scan function information 203 generated by the general-purpose scan software 202. As a result, the process proceeds to the step S505.

Next, in the step S505, the CPU 111 controls the scan function-extending unit 206 to determine whether or not the function and its option, being currently selected for determination, exist in the functions and their options supported by the extension application 204. If it is determined by the CPU 111 via the scan function-extending unit 206 that the function and its option, being currently selected for determination, exist in the functions and their options supported by the extension application 204, the process proceeds to the step S506. Specifically, for example, in a case where the function and its option, being currently selected for determination, is “reading size: A4H”, this option also exists in the table 602 which is the list of the capabilities information of the extension application 204. Therefore, in this case, it is determined by the CPU 111 via the scan function-extending unit 206 that the function and its option, being currently selected for determination, exist in the functions and their options supported by the extension application 204. As a result, the process proceeds to the step S506.

On the other hand, if it is determined by the CPU 111 via the scan function-extending unit 206 that the function and its option, being currently selected for determination, do not exist in the functions and their options supported by the extension application 204, the process returns to the step S504. At this time, the CPU 111 controls the scan function-extending unit 206 to select a next item from the functions and options included in the capabilities information acquired from the scanning device 102 and execute the step S504 again. However, if the final item of the functions and options included in the capabilities information acquired from the scanning device 102 is being processed by the scan function-extending unit 206, the CPU 111 terminates the editing process in FIG. 5.

Then, in the step S506, the CPU 111 controls the scan function-extending unit 206 to add the function and its option being currently selected for determination to the scan function information 203. After that, the process returns to the step S504. At this time, the CPU 111 controls the scan function-extending unit 206 to select a next item from the functions and options included in the capabilities information acquired from the scanning device 102 and execute the step S504 again. However, if the final item of the functions and options included in the capabilities information acquired from the scanning device 102 is being processed by the scan function-extending unit 206, the CPU 111 terminates the editing process in FIG. 5.

As described above, the CPU 111 controls the scan function-extending unit 206 to add, to the scan function information 203, a function and its option which are not supported by the general-purpose scan software 202 but are supported by the scanning device 102 and at the same time are supported by the extension application 204. The scan capabilities are determined based on the scan function information 203 edited according to this editing process. Further, the scan setting screen-extending unit 205 generates a display screen based on the determined scan capabilities. With this, a function which is not supported by the general-purpose scan software 202 is added, and at the same time, options to be displayed are selected, which makes it possible to display the detailed setting screen shown in FIG. 3C.

From the above, it can be said that the CPU 111 of the host computer 101 changes the control items included in the detailed setting screen shown in FIG. 3C based on the capabilities information of the general-purpose scan software 202 by using the extension application 204. Further, it can be said that the CPU 111 of the host computer 101 changes the control items included in the detailed setting screen shown in FIG. 3C based on the capabilities information of the scanning device 102 by using the extension application 204.

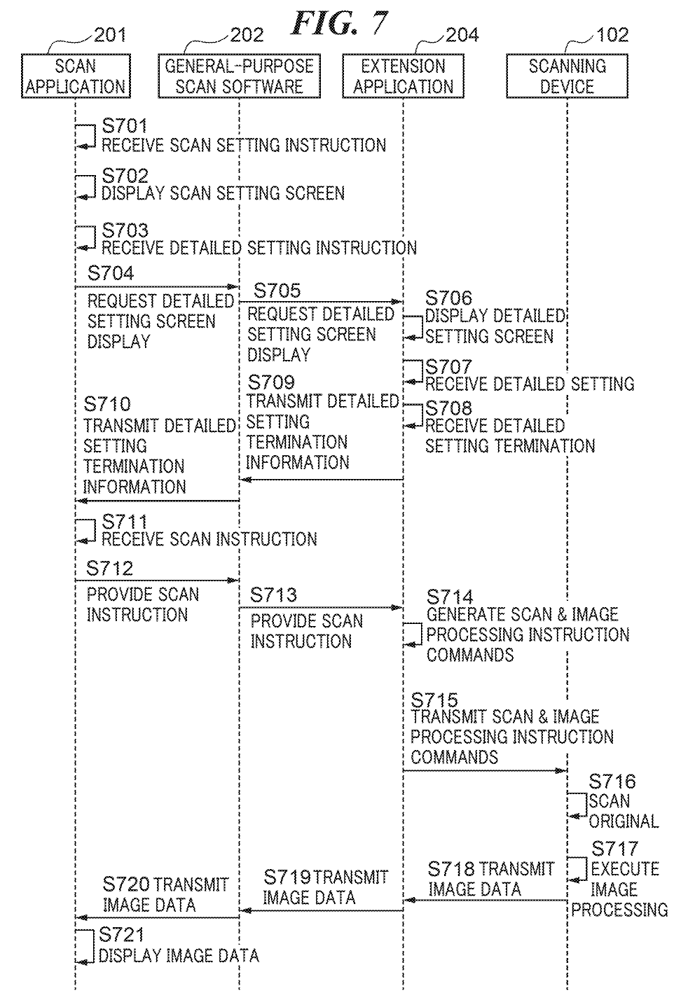

Next, a scan process executed by the scan application 201, the general-purpose scan software 202, the extension application 204, and the scanning device 102 after the scan application 201 receives a scan setting instruction will be described with reference to FIG. 7. Steps in FIG. 7, other than steps executed by the scanning device 102, are realized by the CPU 111 that starts the scan application 201, the general-purpose scan software 202, and the extension application 204 in the host computer 101. On the other hand, the steps executed by the scanning device 102 are realized by the CPU 131 that loads a program read out from the ROM 132 or the external storage device 139 into the RAM 133 and executes the loaded program. Note that the scan process in FIG. 7 is executed assuming the case where the software configuration of the scan system is the configuration shown in FIG. 2B.

First, in a step S701, the CPU 111 of the host computer 101 controls the scan application 201 to receive the scan setting instruction from a user. The user can instruct the scan application 201 to make scan settings by operating the keyboard 118 and the pointing device 119. Next, in a step S702, the CPU 111 controls the scan application 201 to display the scan setting screen shown in FIG. 3A on the display section 120. Then, in a step S703, the CPU 111 controls the scan application 201 to receive a detailed setting instruction. The user can instruct the detailed setting by operating e.g. the pointing device 119 to select the control item 304.

Next, in a step S704, the CPU 111 controls the scan application 201 to request the general-purpose scan software 202 to display the detailed setting screen. Then, in a step S705, the CPU 111 controls the general-purpose scan software 202 to request the extension application 204 to display the detailed setting screen. Note that in a case where the software configuration of the scan system is the configuration shown in FIG. 2A differently from the assumption, as described above, the detailed setting screen shown in FIG. 3B is displayed on the display section 120 by the general-purpose scan software 202.

Next, in a step S706, the CPU 111 (display unit) controls the scan setting screen-extending unit 205 of the extension application 204 to display the detailed setting screen shown in FIG. 3C on the display section 120 (display step). Note that as described hereinabove, the functions of the reading size and so forth have been added to the scan function information 203 by the scan function-extending unit 206. Therefore, the scan setting screen-extending unit 205 generates the detailed setting screen shown in FIG. 3C by referring to the scan capabilities generated based on the scan function information 203, to which these functions have been added, and displays the generated detailed setting screen on the display section 120.

Then, in a step S707, the CPU 111 controls the scan setting screen-extending unit 205 to receive detailed settings. In a case of the detailed setting screen shown in FIG. 3C, the scan setting screen-extending unit 205 receives the settings of “scanning location: feeder”, “reading size: A4H”, and “2-in-1: on”, made by the user. Further, the scan setting screen-extending unit 205 receives the settings of “laid-out image size: A4R” and “layout direction: from left to right”, made by the user. Further, the CPU 111 stores the received function settings in the RAM 113 together with the settings of these functions. Next, in a step S708, the CPU 111 controls the scan setting screen-extending unit 205 to receive termination of the detailed setting. Further, the CPU 111 controls the scan setting screen-extending unit 205 to write the received function settings in the scan setting information together with the settings of these functions. The user can instruct termination of the detailed setting by operating e.g. the pointing device 119 to select the control item 306.

Note that in a case where the detailed setting is terminated, the scan setting screen-extending unit 205 stores the scan setting information in the shared information 209. Further, the scan setting screen-extending unit 205 closes the detailed setting screen shown in FIG. 3C on the display section 120. Further, in a case where the received function settings are written into the scan setting information, the settings of a function and an option which cannot be made by the user, such as resolution, can be written into the scan setting information.

Then, in a step S709, the CPU 111 controls the extension application 204 to transmit detailed setting termination informationto the general-purpose scan software 202. Next, in a step S710, the CPU 111 controls the general-purpose scan software 202 to transmit the detailed setting termination information to the scan application 201. Then, in a step S711, the CPU 111 controls the scan application 201 to receive a scan instruction. The user can provide the scan instruction by operating e.g. the pointing device 119 to select the control item 302. Next, in a step S712, the CPU 111 controls the scan application 201 to provide the scan instruction to the general-purpose scan software 202.

Then, in a step S713, the CPU 111 controls the general-purpose scan software 202 to provide the scan instruction to the extension application 204. Next, in a step S714, the CPU 111 controls the extension application 204 to generate commands for instructing scanning and image processing based on the scan setting information written in the step S708. Note that in a case where the settings of a function and an option which cannot be made by the user, such as resolution, has not been written in the scan setting information, when the scan instruction command is generated in the step S714, the settings can be added to the scan instruction command by the extension application 204. Further, for the settings of a function and an option which cannot be made by the user, such as resolution, the scanning device 102 can be operated with a default value of the scanning device 102 without adding the settings to the scan instruction command.

Next, in a step 715, the CPU 111 controls the extension application 204 to transmit the commands for instructing scanning and image processing to the scanning device 102. With this, the extension application 204 instructs the scanning device 102 to perform scanning. Then, in a step S716, the CPU 131 of the scanning device 102 interprets the scan instruction command and executes scanning of originals. Then, in a step S717, the CPU 131 interprets the image processing instruction command and executes image processing. With this, the CPU 131 executes necessary image processing on the image data acquired by reading the originals according to the image processing instruction command.

Specifically, the CPU 131 performs the 2-in-1 processing based on the reading size, the 2-in-1 processing, the laid-out image size, the layout direction, and so forth, set in the step S707. In the 2-in-1 processing, the CPU 131 performs the following processing on two images out of the images acquired by reading the plurality of original sheets via the feeder: The CPU 131 lays out these two images according to the layout direction set in the step S707 while reducing or enlarging the images according to the reading size and the laid-out image size, set in the step S707. Note that details of the 2-in-1 processing flow will be described hereinafter. Further, the CPU 131 performs processing (such as compression processing, resolution conversion, and format conversion) for converting the image data after being subjected to the image processing to image data for transmission. With this, the image data for transmission is generated.

Then, in a step S718, the CPU 131 transmits the generated image data to the extension application 204 of the host computer 101. Next, in a step S719, the CPU 111 of the host computer 101controls the extension application 204 to transmit the image data to the general-purpose scan software 202. Then, in a step S720, the CPU 111 controls the general-purpose scan software 202 to transmit the image data to the scan application 201. Next, in a step S721, the CPU 111 controls the scan application 201 to receive the image data. Further, the CPU 111 controls the scan application 201 to display the image data. Then, the scan process in FIG. 7 is terminated.

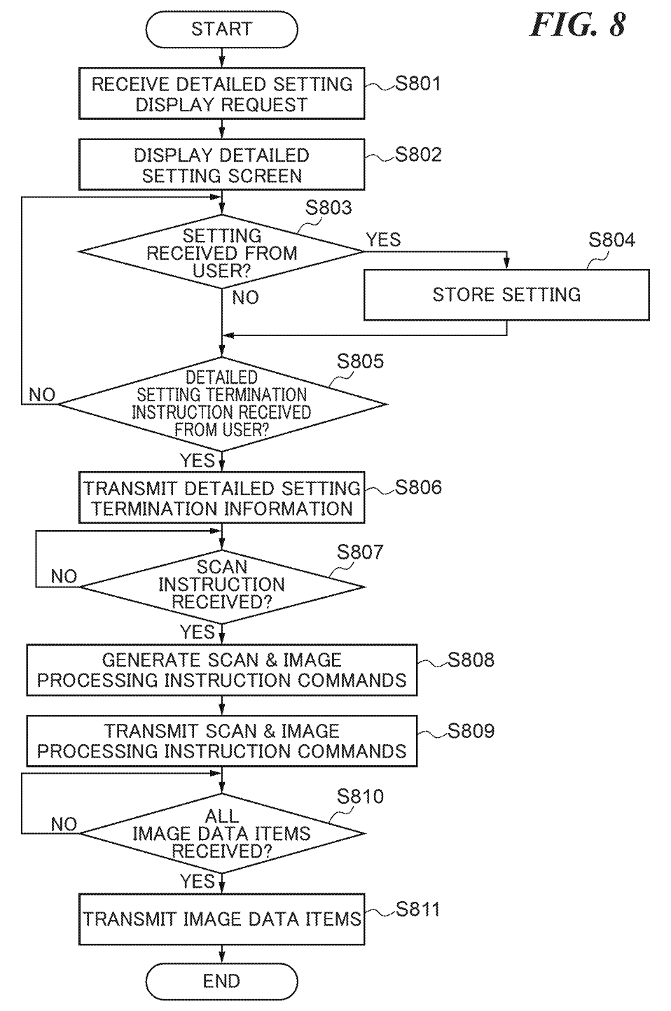

Next, the process performed by the extension application 204 after the scan application 201 receives a scan setting instruction will be described with reference to FIG. 8. Steps of the process in FIG. 8 are realized by the CPU 111 that loads the extension application 204 read out from the external storage device 114 into the RAM 113 and executes the extension application 204 in the host computer 101. When the process in FIG. 8 is started, in a step S801, the CPU 111 controls the extension application 204 to receive a detailed setting display request.

Next, in a step S802, the CPU 111 controls the scan setting screen-extending unit 205 of the extension application 204 to display the detailed setting screen shown in FIG. 3C on the display section 120. This is because, as described above, the functions of the reading size, the 2-in1 processing, the laid-out image size, and the layout direction have been added to the scan function information 203 by the scan function-extending unit 206. That is, the scan setting screen-extending unit 205 displays the detailed setting screen shown in FIG. 3C on the display section 120 by referring to the scan capabilities generated based on the scan function information 203 to which the above-mentioned functions have been added.

Then, in a step S803, the CPU 111 controls the scan setting screen-extending unit 205 to determine whether or not a setting has been received from the user. If it is determined by the CPU 111 via the scan setting screen-extending unit 205 that a setting has not been received from the user, the process proceeds to a step S805, described hereinafter. On the other hand, if it is determined by the CPU 111 via the scan setting screen-extending unit 205 that a setting has been received from the user, the process proceeds to a step S804. In the step S804, the CPU 111 controls the scan setting screen-extending unit 205 to store the setting. That is, the scan setting screen-extending unit 205 receives a setting of a function from the user and stores the received setting of the function in the RAM 113 with a setting made for this function.

Then, in the step S805, the CPU 111 controls the scan setting screen-extending unit 205 to determine whether or not a detailed setting termination instruction has been received from the user. Note that the user can instruct termination of the detailed setting by operating e.g. the pointing device 119 to select the control item 306. If it is determined by the CPU 111 via the scan setting screen-extending unit 205 that the detailed setting termination instruction has not been received from the user, the process returns to the step S803. On the other hand, if it is determined by the CPU 111 via the scan setting screen-extending unit 205 that the detailed setting termination instruction has been received from the user, the process proceeds to a step S806. At this time, when the CPU 111 receives the detailed setting termination instruction via the scan setting screen-extending unit 205, the CPU 111 writes the received function settings and their settings in the scan setting information.

In the step S806, the CPU 111 controls the extension application 204 to transmit the detailed setting termination information to the general-purpose scan software 202. Then, in a step S807, the CPU 111 controls the extension application 204 to determine whether or not a scan instruction has been received from the general-purpose scan software 202. If it is determined by the CPU 111 via the extension application 204 that the scan instruction has not been received from the general-purpose scan software 202, the process returns to the step S807. With this, the CPU 111 controls the extension application 204 to determine again whether or not a scan instruction has been received from the general-purpose scan software 202. On the other hand, if it is determined by the CPU 111 via the extension application 204 that the scan instruction has been received from the general-purpose scan software 202, the process proceeds to a step S808.

In the step S808, CPU 111 controls the extension application 204 to generate commands for instructing scan and image processing based on the scan setting information written in the step S805. At this time, the extension application 204 adds the function setting of the reading size and its settings to the scan instruction command. As the method of adding the setting of the reading size, a method of describing an identifier (ID) indicating a regular size, such as A4H, a method of describing a value obtained by converting a regular size to a millimeter size, or a method of describing a value obtained by converting a regular size to pixels by taking a resolution into account can be used. Further, the extension application 204 adds the function settings of the 2-in-1 processing, the laid-out image size, and the layout direction, and their settings to the image processing instruction command.

Further, as the method of generating commands for instructing scan and image processing in the step S808, the extension application 204 uses a method of extending a standard protocol command. This extension method is a method of describing dedicated commands in an extended area of the standard protocol command. Note that the other methods of generating the commands for instructing scan and image processing include a method of adding an original standard command to the end of the standard protocol command, a method of the extension application 204 overwriting the standard protocol command with an original command system, and so forth. Further, in a case where an instruction is provided from the extension application 204, the CPU 111 can perform instruction and communication according to a protocol unique to a maker regardless of the standard protocol.

Next, in a step S809, the CPU 111 controls the extension application 204 to transmit the commands for instructing scan and image processing to the scanning device 102. With this, the extension application 204 instructs scanning and image processing to the scanning device 102. Note that the scan instruction is an instruction for reading originals according to the setting of the reading size. The image processing instruction is an instruction for performing the 2-in-1 processing according to the settings of the reading size, the 2-in-1 processing, the laid-out image size, and the layout direction.

Then, in a step S810, the CPU 111 controls the extension application 204 to determine whether or not all of the image data items have been received from the scanning device 102. If it is determined by the CPU 111 via the extension application 204 that all of the image data items have not been received, the process remains in the step S810. With this, the extension application 204 determines again whether or not all of the image data items have been received from the scanning device 102. On the other hand, it is determined by the CPU 111 via the extension application 204 that all of the image data items have been received from the scanning device 102, the process proceeds to a step S811. In the step S811, the CPU 111 controls the extension application 204 to transmit all of the image data acquired by the reception to the general-purpose scan software 202. After that, the process in FIG. 8 is terminated.

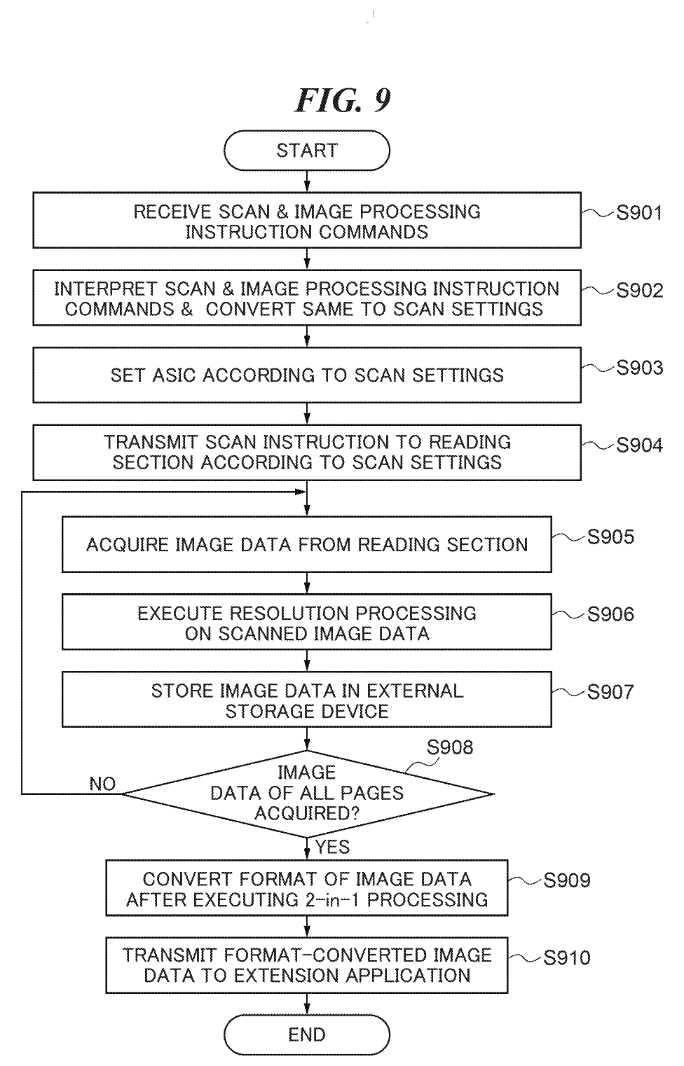

Next, the process performed by the scanning device 102 after the scan application 201 receives a scan setting instruction will be described with reference to FIG. 9. Steps of the process in FIG. 9 are realized by the CPU 131 that loads a program read out from the ROM 132 or the external storage device 139 into the RAM 133 and executes the loaded program in the scanning device 102. When the process in FIG. 9 is started, in a step S901, the CPU 131 receives the commands for instructing scan and image processing, which are transmitted from the host computer 101. Note that in the first embodiment, the CPU 131 receives the commands for instructing scan and image processing, which are transmitted from the extension application 204.

Next, in a step S902, the CPU 131 interprets the commands for instructing scan and image processing, which have been received in the step S901, and converts the commands for instructing scan and image processing to reading settings used when executing original reading and image processing. Note that in the first embodiment, the reading settings converted from the scan instruction command are “scanning location: feeder”, “reading size: A4H”, and “resolution: 300 × 300 dpi”. Further, the reading settings converted from the image processing instruction command are “2-in-1: on”, “laid-out image size: A4R”, and “layout direction: from left to right”.

Next, in a step S903, the CPU 131 determines an application specific integrated circuit (ASIC) of the image processor 138, which is to be used to execute original reading and image processing according to the reading settings converted in the step S902, and makes setting with respect to the determined ASIC. In a step S904, the CPU 131 transmits a reading instruction based on the reading settings converted in the step S902 to the reading section 135. With this, in the first embodiment, the CPU 131 instructs the reading section 135 to execute original reading with the settings of “scanning location: feeder” and “reading size: A4H”.

In a step S905, the CPU 131 acquires image data from the reading section 135. With this, in the first embodiment, the CPU 131 acquires the image data of the A4H size. In a step S906, the CPU 131 controls the image processor 138 to execute resolution processing on the image data acquired in the step S905. In the first embodiment, processing for converting the image data to “resolution: 300 × 300 dpi” is performed. Note that in a case where the reading section 135 is capable of performing reading at the “resolution: 300 × 300 dpi”, the CPU 131 acquires the image data at the “resolution of 300 × 300 dpi” by the reading section 135, and the resolution processing in the step S906 can be omitted. In a step S907, the CPU 131 stores the image data in the external storage device 139.

In a step S908, the CPU 131 determines whether or not image data of all pages has been acquired. If it is determined by the CPU 131 that image data of all of the pages has not been acquired, the process returns to the step S905. With this, the CPU 131 acquires image data of the next page from the reading section 135. On the other hand, if it is determined by the CPU 131 that image data of all of the pages has been acquired, the process proceeds to a step S909. In the step S909, the CPU 131 controls the image processor 138 to convert the format of the image data items stored in the step S907 after performing the 2-in-1 processing according to the image processing instruction command received in the step S901.

At this time, in the first embodiment, the image processor 138 performs the 2-in-1 processing on the image data items stored in the step S907 according to the reading settings of “2-in-1: on”, “laid-out image size: A4R”, and “layout direction: from left to right”. Further, the image processor 138 converts the format of the image data items after being subjected to the 2-in-1 processing according a transmission format setting. However, in the first embodiment, the transmission format setting is not described in the commands for instructing scan and image processing, which are transmitted from the extension application 204. Therefore, in the first embodiment, the image processor 138 coverts the format of the image data items after being subjected to the 2-in-1 processing to the JPEG file format. However, the converted format (i.e. transmission format) is not limited to this and is only required to be a format which can be handled by the host computer 101.

In a step S910, the CPU 131 transmits the image data to the host computer 101. Note that in the first embodiment, the CPU 131 transmits the image data whose format has been converted in the step S909 to the extension application 204. After that, the process in FIG. 9 is terminated.

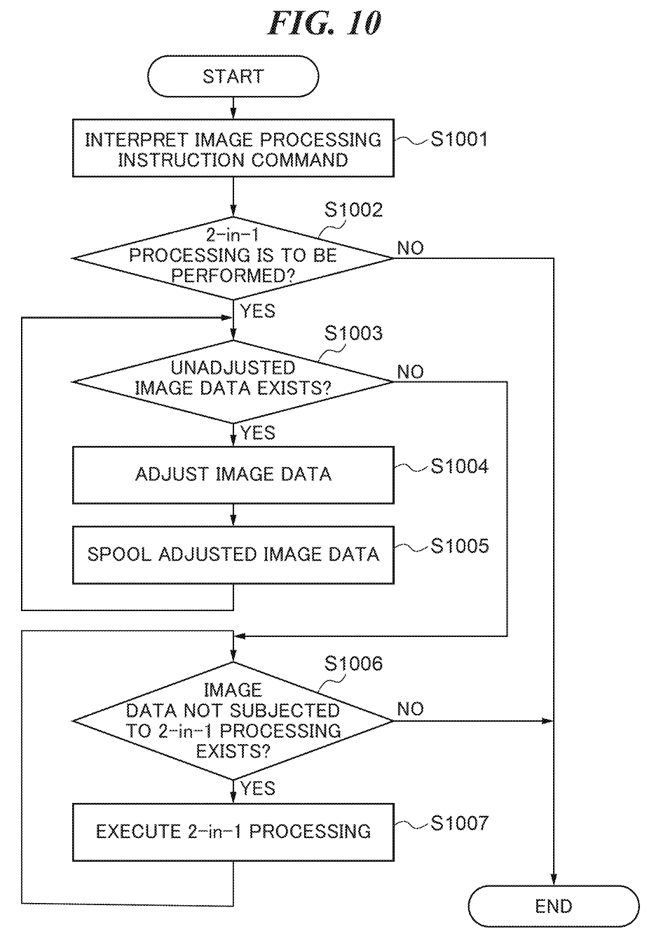

Next, the 2-in-1 processing will be described with reference to FIG. 10. Steps of a process shown in FIG. 10 are realized by the CPU 131 that reads out image data items from the external storage device 139, loads a program read out from the ROM 132 or the external storage device 139 into the RAM 133, and executes the loaded program in the scanning device 102. When the process in FIG. 10 is started, in a step S1001, the CPU 131 interprets the image processing instruction command. In the first embodiment, the image processing instruction command is an instruction command to which the function settings of the 2-in-1 processing, the laid-out image size, and the layout direction, and their settings have been added.

Next, in a step S1002, the CPU 131 determines whether or not to perform the 2-in-1 processing. This determination is performed based on the setting of the 2-in-1 processing, which has been interpreted in the step S1001. If it is determined by the CPU 131 that the 2-in-1 processing is not to be performed, i.e., if the setting of the 2-in-1 processing, which has been interpreted in the step S1001, is “off”, the process in FIG. 10 is terminated. On the other hand, if it is determined by the CPU 131 that the 2-in-1 processing is to be performed, i.e., if the setting of the 2-in-1 processing, which is interpreted in the step S1001, is “on”, the process proceeds to a step S1003.

Next, in the step S1003, the CPU 131 determines whether or not all image data items spooled in the external storage device 139 include image data items not adjusted. Note that all the image data items spooled in the external storage device 139 refer to image data items acquired by original reading. If it is determined by the CPU 131 that all the image data items spooled in the external storage device 139 include no image data items not adjusted, the process proceeds to a step S1006, described hereinafter. On the other hand, if it is determined by the CPU 131 that in all the image data items spooled in the external storage device 139 include image data items not adjusted, the process proceeds to a step S1004.

Next, in the step S1004, the CPU 131 adjusts the image data items. Specifically, the CPU 131 acquires a magnification/reduction ratio by comparing the image size (i.e. the reading size) of the image data items being currently processed and the laid-out image size. Further, the CPU 131 enlarges or reduces the image size of the image data items currently being processed by using the acquired magnification/reduction ratio. For example, in a case where the image size of the image data items currently being processed and the laid-out image size are both the A4 size, the image size of the image data items currently being processed is reduced to 1/2. Further, in a case where the image size of the image data items currently being processed is the A4 size, but the laid-out image size is the A3 size, the image size of the image data items currently being processed is not required to be enlarged or reduced. In this case, the image data items currently being processed are spooled in the external storage device 139 as the adjusted image data items.

Next, in a step S1005, the CPU 131 spools the image data items adjusted in the step S1004, in the external storage device 139. After that, the process returns to the step S1003. Next, in the step S1006, the CPU 131 determines whether or not the adjusted image data items spooled in the external storage device 139 include image data items not subjected to the 2-in-1 processing. If it is determined by the CPU 131 that the adjusted image data items spooled in the external storage device 139 include no image data items not subjected to the 2-in-1 processing, the process in FIG. 10 is terminated. On the other hand, if it is determined by the CPU 131 that the adjusted image data items spooled in the external storage device 139 include image data items not subjected to the 2-in-1 processing, the process proceeds to a step S1007.

Next, in the step S1007, the CPU 131 performs the 2-in-1 processing on the adjusted image data items. Specifically, the CPU 131 performs the 2-in-1 processing by laying out, based on the settings of the laid-out image size and the layout direction, which have been interpreted in the step S1001, the adjusted image data items in the laid-out image size and the layout direction. After that, the process returns to the step S1006. This concludes the description of the 2-in-1 processing.

As described above, in the first embodiment, the scan function-extending unit 206 of the extension application 204 edits the scan function information 203 in the host computer 101. This edit processing is performed based on the capabilities information of the scanning device 102, the scan functions supported by the extension application 204, and the scan function information 203 generated by the general-purpose scan software 202. Further, when the user provides a detailed setting instruction, the scan setting screen-extending unit 205 of the extension application 204 displays the detailed setting screen generated by referring to the scan capabilities generated based on the scan function information 203. With this, the user can make settings of the reading size, the 2-in-1 processing, the laid-out image size, the layout direction, and so forth.

After that, the scanning device 102 receives the commands for instructing scan and image processing, to which the function settings of the reading size, the 2-in-1 processing, the laid-out image size, the layout direction, and so forth, and their settings have been added. With this, the scanning device 102 reads originals (performs original reading) according to the set reading size and performs the 2-in-1 processing on images acquired by original reading, according to the set 2-in-1 processing, laid-out image size, and layout direction. With the above-described series of processing operations, the extension application 204 of the host computer 101 can lay out respective images on a plurality of pages, which are acquired by the scanning device 102 that scans originals using the general-purpose scan software 202, in one page.

Note that although in the first embodiment, in the configuration shown in FIG. 2B, the detailed setting screen shown in FIG. 3B is not additionally displayed, but the detailed setting screen shown in FIG. 3C is additionally displayed, the present disclosure is not limited to this. For example, in a case where the detailed setting display request is provided to the general-purpose scan software 202 in the step S704, the CPU 111, first, controls the general-purpose scan software 202 to additionally display the detailed setting screen shown in FIG. 3B. Further, after the detailed setting on the detailed setting screen shown in FIG. 3B is terminated, the CPU 111 controls the general-purpose scan software 202 to provide a detailed setting display request to the extension application 204. The CPU 111 can control the extension application 204 to additionally display the detailed setting screen shown in FIG. 3C, on which the scanning location has been set but the reading size and the like have not been set, via the above-described processing. Further, the CPU 111 can control the extension application 204 to additionally display the control items 308 to 311 and the lists 312 to 315 on the detailed setting screen shown in FIG. 3B, on which the scanning location has been set.

Further, although in the first embodiment, in the configuration shown in FIG. 2B, the CPU 111 controls the general-purpose scan software 202 to provide a scan instruction to the extension application 204, the present disclosure is not limited to this. For example, the CPU 111 can control the scan application 201 to provide a scan instruction to the extension application 204. Further, the user can directly provide a scan instruction to the extension application 204 by operating e.g. the pointing device 119 to select a control item provided on the detailed setting screen shown in FIG. 3C, for instructing scan.

Further, although in the first embodiment, in the configuration shown in FIG. 2B, the CPU 111 transmits image data items from the extension application 204 to the scan application 201 via the general-purpose scan software 202, the present disclosure is not limited to this. For example, the CPU 111 can transmit image data items directly from the extension application 204 to the scan application 201 without via the general-purpose scan software 202. Further, the CPU 111 can transmit image data items directly from the scanning device 102 to the scan application 201 without via the extension application 204 and the general-purpose scan software 202.

Further, the CPU 111 can store the image data items received from the scanning device 102 in the external storage device 114 and transmit only information on a file path to the storage destination to the extension application 204, the general-purpose scan software 202, or the scan application 201. Further, in the first embodiment, in a case where there are a plurality of image data items, the CPU 111 acquires all of the image data items and then transmits all of the acquired image data items, the present disclosure is not limited to this. For example, the CPU 111 can transmit an acquired image data item whenever the image data item is acquired.

Further, although in the first embodiment, the layout processing has been described assuming that the plurality of pages are two pages (i.e. the 2-in-1 processing), the present disclosure is not limited to this. For example, the number of the plurality of pages in the layout processing (i.e. N of N-in-1 processing) can be set to two or more by a user. In this case, for example, the CPU 111 adds control items 326 and 327 and lists 328 and 329, appearing in FIG. 3F, in place of the control item 309 and the list 313, on the detailed setting screen shown in FIG. 3C. The control item 326 enables the user to set whether or not to perform the N-in-1 processing, and FIG. 3F shows a state in which “off” is set. When the control item 326 is selected by using e.g. the pointing device 119, setting items which can be set by the control item 326 are indicated by the list 328. The list 328 indicates that the setting items which can be set by the control item 326 include not only “off”, currently set, but also “on”.

The control item 327 enables the user to set a value of N in the N-in-1 processing, and FIG. 3F shows a state in which “2” is set. When the control item 327 is selected by using e.g. the pointing device 119, setting items which can be set by the control item 327 are indicated by the list 329. The list 329 indicates that the setting items which can be set by the control item 327 include not only “2”, currently set, but also “3” and “4”. With this, the user can set the N-in-1 processing to “on” or “off” by using the control item 326 and the list 328 and set a value of N in the N-in-1 processing to “2”, “3”, or “4” by using the control item 327 and the list 329.

Further, the scanning devices 102 have a variety of types, and for example, there is a case where the reading section 135 of the scanning device 102 can read only an original of up to the A4 size. In this case, when a carrier sheet mode is set, the scanning device 102 can read an original of the A3 size. To do this, first, the CPU 111 of the host computer 101 displays a detailed setting screen shown in FIG. 3D on the display section 120 in place of the detailed setting screen shown in FIG. 3C. The detailed setting screen shown in FIG. 3D is a UI screen (first screen) generated by adding not only the control item 308 and the list 312, described above, but also control items 316 and 317 and lists 318 and 319 to the detailed setting screen shown in FIG. 3B.

On the detailed setting screen shown in FIG. 3D, the user can set the carrier sheet mode by using the control item 316 and the list 318. The control item 316 enables the user to set whether or not to set the carrier sheet mode, and FIG. 3D shows a state in which “off” is set. When the control item 316 is selected by using e.g. the pointing device 119, setting items which can be set by the control item 316 are indicated by the list 318. The list 318 indicates that the setting items which can be set by the control item 316 include not only “off”, currently set, but also “on”. Therefore, the user sets “carrier mode: on” by using the control item 316 and the list 318 on the detailed setting screen shown in FIG. 3D. Note that the control item 317 and the list 319 will be described hereinafter.

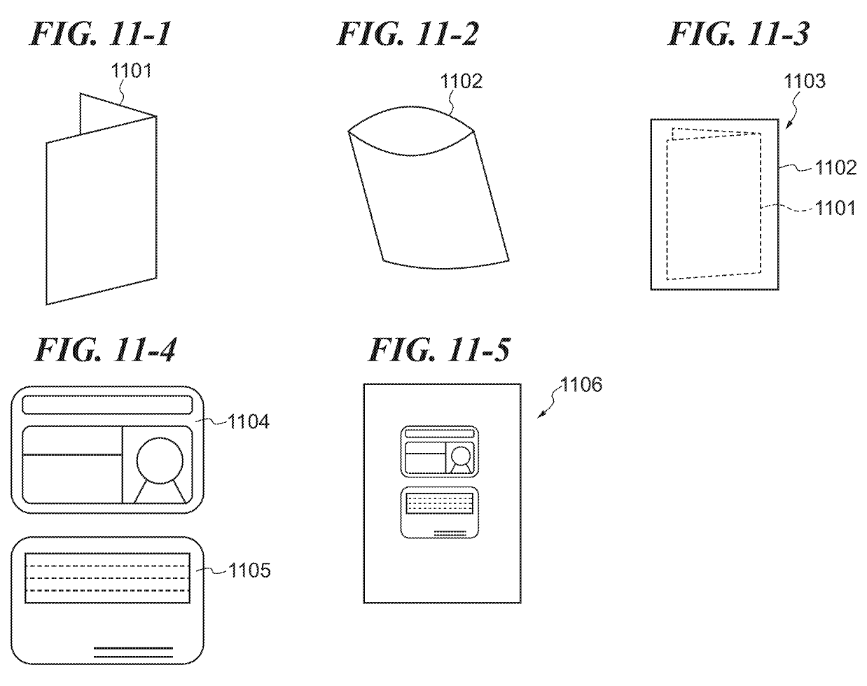

Further, to cause the reading section 135 of the scanning device 102 that can read only an original of up to the A4 size to read an original of the A3 size, as indicated by reference numeral 1101 in FIG. 11-1, the original of the A3 size is folded into two in the A4 size. After that, the original folded into two in the A4 size is accommodated in a transparent carrier sheet 1102 (transparent sheet) shown in FIG. 11-2, thereby being put into a state as indicated by reference numeral 1103 in FIG. 11-3. Further, by setting, on the feeder, the original which has been put in the state as indicated by the reference numeral 1103 in FIG. 11-3 by accommodating the original in the transparent carrier sheet 1102, the reading section 135 of the scanning device 102 that can read only an original of up to the A4 size is caused to perform double-sided reading. Thus, a front surface image and a reverse surface image of the A4 size, which are acquired by the double-sided reading performed by the reading section 135 of the scanning device 102, are laid out into one image of the A3 size by performing the 2-in-1 processing. Note that FIGS. 11-4 and 11-5 will be described hereinafter.

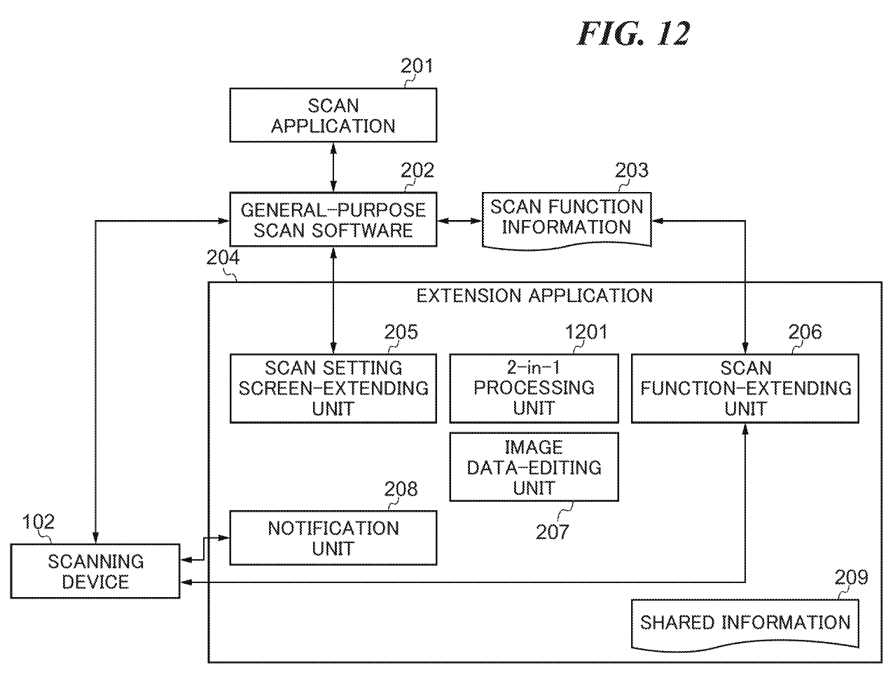

A second embodiment will be described below with reference to FIGS. 12 to 15. Although in the first embodiment, the layout processing is performed by the scanning device 102, depending on the scanning device, there is a case where the layout processing cannot be performed, due to consideration of costs and the like. In this case, even when the extension application 204 can generate the scan setting information including the setting related to the layout processing, it is impossible to cause the scanning device to execute the layout processing. To cope with this, in the second embodiment, the extension application 204 first determines, based on the capabilities information of a scanning device, whether or not the layout processing can be performed by the scanning device. Then, if it is determined that the layout processing can be performed, the extension application 204 generates the scan setting information including the setting related to the layout processing. Further, the extension application 204 passes the generated scan setting information to the scanning device.

On the other hand, if it is determined that the layout processing cannot be performed by the scanning device, the extension application 204 generates the scan setting information including information indicating that the layout processing is to be performed by the extension application 204. Further, the extension application 204 passes the generated scan setting information to the scanning device 102. In response to this, the scanning device 102 transmits image data items acquired by original reading to the extension application 204. The extension application 204 causes the CPU 111 of the host computer101 to perform the layout processing by using the image data items received from the scanning device 102. With this, even when the layout processing cannot be performed by the scanning device 102, it is possible to provide the layout processing to the user by using the extension application 204. Note that also in the second embodiment, the description is given assuming that the plurality of pages in the layout processing are two pages.

The following description of the second embodiment will be given only of differences from the first embodiment. Further, components and processing operations in FIGS. 12 to 15, which are denoted by the same reference numerals as in the first embodiment, have already been described in the first embodiment, and hence description thereof is omitted. The second embodiment differs from the first embodiment in four points of the software configuration of the scan system, i.e. the capabilities information of the scanning device 102, the process for editing the scan function information 203, and the scan process executed after the scan application 201 receives a scan setting instruction.

The software configuration of the scan system in the case where the extension application 204 is associated with the general-purpose scan software 202 and the scanning device 102 will be described with reference to FIG. 12. The extension application 204 includes a 2-in-1 processing unit 1201 in addition to the above-described scan setting screen-extending unit 205, scan function-extending unit 206, image data-editing unit 207, notification unit 208, and shared information 209. The 2-in-1 processing unit 1201 performs the 2-in-1 processing on image data items received from the image data-editing unit 207 based on the set reading size, 2-in-1 processing, laid-out image size, layout direction, and so forth.

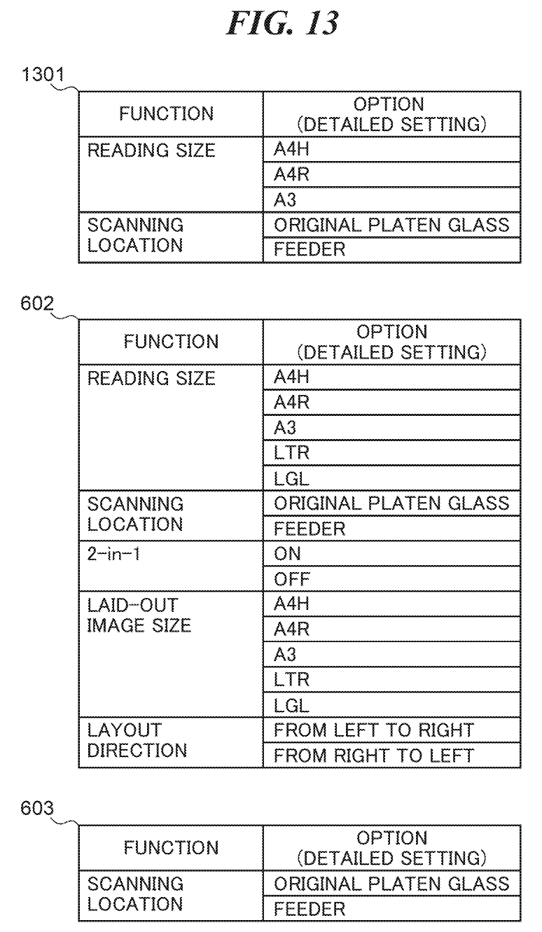

In the second embodiment, the scanning device 102 is a scanning device which does not support the 2-in-1 processing. Therefore, a table showing an example of a list of the capabilities information acquired from the scanning device 102 is not the above-described table 601 shown in FIG. 6 but a table 1301 shown in FIG. 13. The table 1301 shown in FIG. 13 is generated by excluding the functions and options of the 2-in-1 processing, the laid-out image size, and the layout direction from the table 601 shown in FIG. 6.

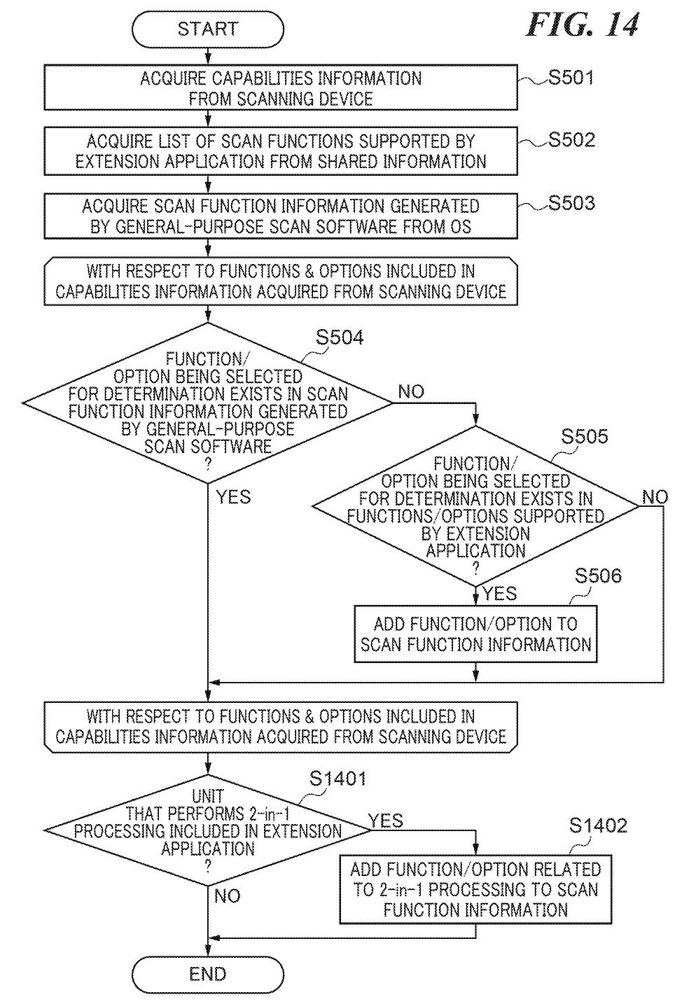

In the second embodiment, as described above, the functions and options of the 2-in-1 processing, the laid-out image size, and the layout direction are not included in the capabilities information acquired from the scanning device 102. However, also in this case, if the extension application 204 has a unit configured to perform the 2-in-1 processing (i.e. the 2-in-1 processing unit 1201), the scan function-extending unit 206 adds the functions and options of the 2-in-1 processing and the like to the scan function information 203. The process for editing the scan function information 203, performed by the scan function-extending unit 206 of the extension application 204, will be described below with reference to FIG. 14. Steps in the editing process in FIG. 14 are realized, in the host computer 101, by the CPU 111 that loads the extension application 204 read out from the external storage device 114 into the RAM 113 and executes the extension application 204.

When the editing process in FIG. 14 is started, the CPU 111 controls the scan function-extending unit 206 to execute the steps S501 to S503. After that, the CPU 111 controls the scan function-extending unit 206 to repeatedly execute the steps S504 to S506. Then, when repetition of the steps S504 to S506 is terminated, the process proceeds to a step S1401. Note that, as described above, the scanning device 102 does not support the 2-in-1 processing. Therefore, the functions and options of the 2-in-1 processing and the like have not been added to the scan function information 203 at a time when the process proceeds to the step S1401. Therefore, in steps S1401 and S1402, if the extension application 204 has a unit (i.e. the 2-in-1 processing unit 1201) that is configured to perform the 2-in-1 processing, the functions and options of the 2-in-1 processing and the like are added to the scan function information 203.

Specifically, in the step S1401, the CPU 111 controls the scan function-extending unit 206 to determine whether or not the extension application 204 has a unit configured to perform the 2-in-1 processing. This determination is performed by referring to the table 602 as the list of the capabilities information of the extension application 204 and the scan function information 203. If it is determined by the CPU 111 via the scan function-extending unit 206 that the extension application 204 does not have a unit configured to perform the 2-in-1 processing, the editing process in FIG. 14 is terminated. On the other hand, if it is determined by the CPU 111 via the scan function-extending unit 206 that the extension application 204 has a unit configured to perform the 2-in-1 processing, the process proceeds to the step S1402. Note that the extension application 204 of the second embodiment has the functions and options related to the 2-in-1 processing in the table 602 as the list of the capabilities information thereof, i.e. has the 2-in-1 processing unit 1201 configured to perform the 2-in-1 processing, and hence the process proceeds to the step S1402.

Next, in the step S1402, the CPU 111 controls the scan function-extending unit 206 to add the functions and options related to the 2-in-1 processing to the scan function information 203. After that, the editing process in FIG. 14 is terminated. Note that in the second embodiment, the information added in the step S1402 is information on the functions and options of the 2-in-1 processing, the laid-out image size, and the layout direction, out of the functions and options included in the table 602 as the list of the capabilities information of the extension application 204.

As described above, the CPU 111 controls the scan function-extending unit 206 to add the functions and options which are not supported by the general-purpose scan software 202 but supported by the scanning device 102 and at the same time supported by the extension application 204, to the scan function information 203. After that, the scan function-extending unit 206 determines whether or not the extension application 204 can perform the 2-in-1 processing. If it is determined that the extension application 204 can perform the 2-in-1 processing, the scan function-extending unit 206 adds the functions and options related to the 2-in-1 processing to the scan function information 203. Then, the CPU 111 controls the scan setting screen-extending unit 205 to generate a detailed setting screen by referring to the scan capabilities determined based on the scan function information 203 and display the generated detailed setting screen on the display section 120. With this, the scan setting screen-extending unit 205 can display the detailed setting screen shown in FIG. 3C on which the reading size, the 2-in-1 processing, the laid-out image size, and the layout direction can be set, even in a case where the scanning device 102 does not support the 2-in-1 processing.

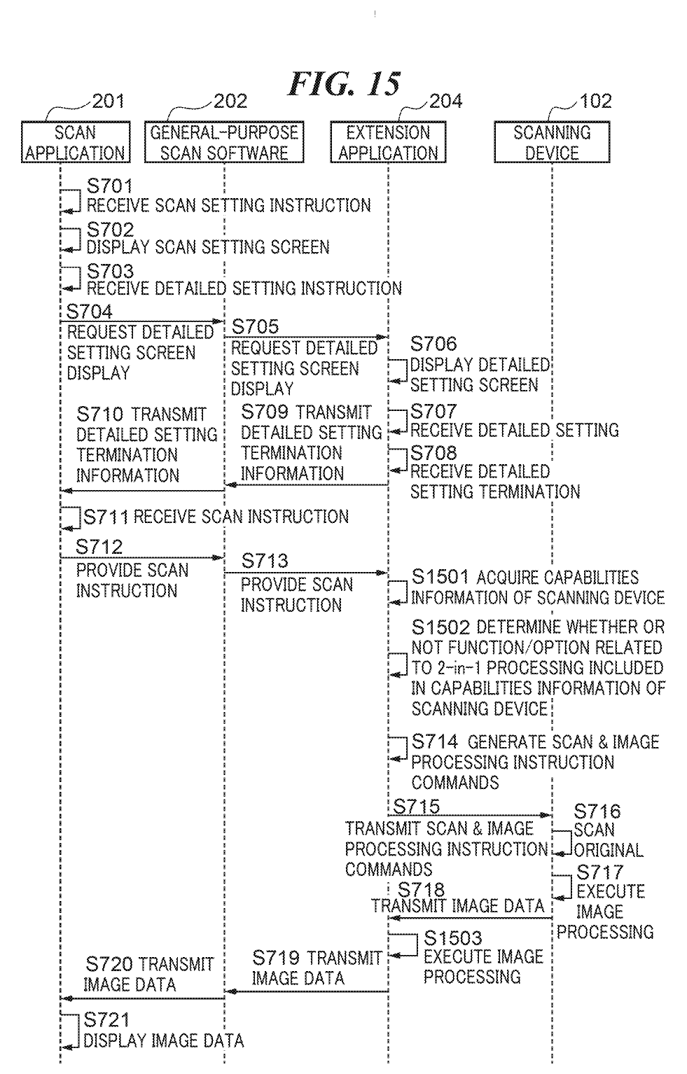

Next, the scan process executed by the scan application 201, the general-purpose scan software 202, the extension application 204, and the scanning device 102 after the scan application 201 receives a scan setting instruction will be described with reference to FIG. 15. Steps in the scan process in FIG. 15, other than steps executed by the scanning device 102 of the host computer 101 are realized by the CPU 111 that starts the scan application 201, the general-purpose scan software 202, and the extension application 204. On the other hand, the steps executed by the scanning device 102 are realized by the CPU 131 that loads a program read out from the ROM 132 or the external storage device 139 into the RAM 133 and executes the loaded program. Note that the scan process in FIG. 15 is executed assuming a case where the software configuration of the scan system is the configuration shown in FIG. 12.

The description of the scan process in FIG. 15 will be given of processing operations executed in steps S1501 to S1503 which are different from the first embodiment. In the step S1501, the CPU 111 of the host computer 101 controls the extension application 204 to acquire the capabilities information of the scanning device 102. Note that the capabilities information of the scanning device 102, acquired in this step, includes not only the scan capabilities of the scanning device 102, such as the functions and options of the reading size, but also the image processing function and the like of the scanning device 102. In the step S1502, the CPU 111 controls the extension application 204 to determine whether or not the functions and options related to the 2-in-1 processing are included in the capabilities information of the scanning device 102. Note that in the second embodiment, it is determined that the functions and options related to the 2-in-1 processing are not included in the capabilities information of the scanning device 102.

In the step S714, the CPU 111 controls the extension application 204 to generate commands for instructing scan and image processing according to the determination in the step S1502. At this time, if it is determined in the step S1502 that the functions and the like related to the 2-in-1 processing are included in the capabilities information of the scanning device 102, the extension application 204 generates an image processing instruction command including a notification to the effect that the 2-in-1 processing is to be performed by the scanning device 102. On the other hand, if it is determined in the step S1502 that the functions and so forth related to the 2-in-1 processing are not included in the capabilities information of the scanning device 102, the extension application 204 generates an image processing instruction command including a notification to the effect that the 2-in-1 processing is to be performed by the extension application 204. Note that in the second embodiment, the scanning device 102 does not support the 2-in-1 processing, and hence the image processing instruction command including the notification to the effect that the 2-in-1 processing is to be performed by the extension application 204 is generated. In the step S715, the CPU 111 controls the extension application 204 to transmit the commands for instructing scan and image processing to the scanning device 102.

In the step S716, the CPU 131 of the scanning device 102 executes original reading according to the scan instruction command. Then, in the step S717, the CPU 131 executes necessary image processing on the image data items acquired by original reading in the step S716 according to the image processing instruction command. At this time, in a case where the notification to the effect that the 2-in-1 processing is to be performed by the scanning device 102 is included in the image processing instruction command, the CPU 131 performs the 2-in-1 processing based on the reading size, the 2-in-1 processing, the laid-out image size, the layout direction, and so forth, which have been set in the step S707. Note that the scanning device 102 is caused to execute the 2-in-1 processing in order to reduce the amount of data transmitted from the scanning device 102 to the extension application 204 of the host computer 101. On the other hand, in a case where the notification to the effect that the 2-in-1 processing is to be performed by the extension application 204 is included in the image processing instruction command, the CPU 131 does not perform the 2-in-1 processing.

Further, the CPU 131 performs processing (image processing, such as compression processing, resolution conversion, and format conversion) for converting the image data items subjected to the image processing to image data items for transmission. With this, the image data items for transmission are generated. In the step S718, the CPU 131 transmits the generated image data items to the extension application 204 of the host computer 101.

In the step S1503, the CPU 111 of the host computer 101 executes necessary image processing on the image data items received from the scanning device 102 according to the image processing instruction command. At this time, as the image processing instruction command, the image processing instruction command generated in the step S714 and stored can be used, or the image processing instruction command received from the scanning device 102 can be used. However, in a case where the notification to the effect that the 2-in-1 processing is to be performed by the scanning device 102 is included in the image processing instruction command, the CPU 111 does not perform the 2-in-1 processing.

On the other hand, in a case where the notification to the effect that the 2-in-1 processing is to be performed by the extension application 204 is included in the image processing instruction command, the CPU 111 controls the 2-in-1 processing unit 1201 of the extension application 204 to perform the 2-in-1 processing. At this time, the 2-in-1 processing unit 1201 performs the 2-in-1 processing on the image data items received from the scanning device 102, based on the reading size, the 2-in-1 processing, the laid-out image size, the layout direction, and so forth, which have been set in the step S707.

Note that the CPU 111 is caused to control the 2-in-1 processing unit 1201 of the extension application 204 to perform the 2-in-1 processing in order to distribute the load in the host computer 101. Thus, the description of the scan process executed after the scan application 201 receives the scan setting instruction is terminated. Note that also in the second embodiment, similar to the first embodiment, the number of the plurality of pages in the layout processing (i.e. N of N-in-1 processing) can be set to two or more by a user.

As described above, in the second embodiment, if the scanning device 102 supports the N-in-1 processing, the extension application 204 of the host computer 101 causes the scanning device 102 to perform the N-in-1 processing according to the settings related to the layout processing. Alternatively, if the scanning device 102 does not support the N-in-1 processing, the extension application 204 causes the CPU 111 of the host computer 101 to perform the N-in-1 processing according to the settings related to the layout processing. Thus, the extension application 204 can cause the scanning device 102 or the CPU 111 of the host computer 101 to perform the N-in-1 processing according to whether or not the scanning device 102 supports the N-in-1 processing. Note that the extension application 204 can cause the CPU 111 of the host computer 101 to perform the N-in-1 processing according to the settings related to the layout processing regardless of whether or not the scanning device 102 supports the N-in-1 processing.

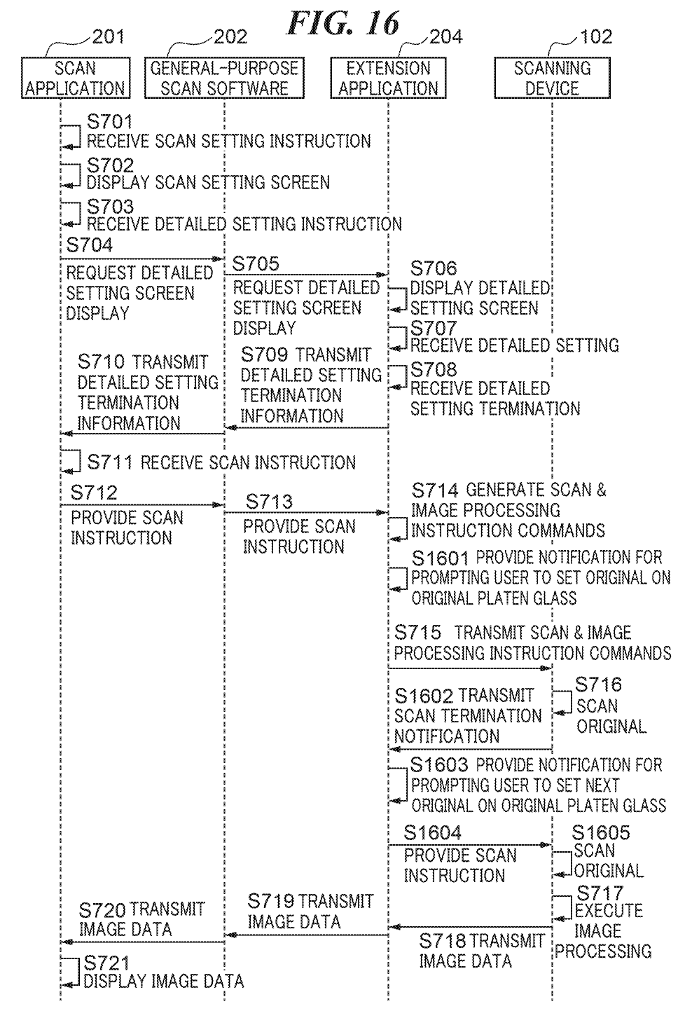

A third embodiment will be described below with reference to FIGS. 16 to 18. In the first and second embodiments, the description has been given of the case where reading of an original is performed on the feeder of the scanning device 102. In the third embodiment, a description will be given of a case where reading of an original is performed on the original platen glass of the scanning device 102, assuming a license mode, by way of example. Note that, to set the license mode, first, the CPU 111 displays the detailed setting screen shown in FIG. 3D on the display section 120 of the host computer 101. On the detailed setting screen shown in FIG. 3D, the user can set the license mode by using the control item 317 and the list 319.

The control item 317 enables the user to set whether or not to set the license mode, and FIG. 3D shows a state in which “off” is set. When the control item 317 is selected by using e.g. the pointing device 119, setting items which can be set by the control item 317 are indicated by the list 319. The list 319 indicates that the setting items which can be set by the control item 317 include not only “off”, currently set, but also “on”. Therefore, the user sets “license mode: on” by using the control item 317 and the list 319 on the detailed setting screen shown in FIG. 3D.

In the license mode, specifically, a front surface1104 and a reverse surface 1105 of a license, shown in FIG. 11-4, are each read once on the original platen glass of the scanning device 102. Further, the respective images of the front surface1104 and the reverse surface 1105 of the license, acquired by this reading, are laid out in one page in the same size as the license as indicated by reference numeral 1106 in FIG. 11-5. Thus, the license mode is performed assuming that reading of an original is performed on the original platen glass of the scanning device 102. Therefore, when “license mode: on” is set by the control item 317 and the list 319, even when “scanning location: feeder” is set by the control item 305 and the list 307, this setting is forcibly changed to “scanning location: original platen glass”. Note that an original for which the license mode is conveniently used is not limited to the license, but for example, a personal number card, a health insurance ID card, an identification card, a medical examination card, a membership card, a business card, a contact card, or a tag sheet can be applied.

The following description of the third embodiment will be given only of differences from the first embodiment. Further, the processing operations in FIG. 16, denoted by the same reference numerals as in the first embodiment, have already been described in the first embodiment, and hence description thereof is omitted. The third embodiment differs from the first embodiment only in the scan process executed after the scan application 201 receives a scan setting instruction.

Then, the scan process executed by the scan application 201, the general-purpose scan software 202, the extension application 204, and the scanning device 102 after the scan application 201 receives a scan setting instruction will be described with reference to FIG. 16. Steps in the scan process in FIG. 16, other than steps executed by the scanning device 102, are realized, in the host computer 101, by the CPU 111 that starts the scan application 201, the general-purpose scan software 202, and the extension application 204. On the other hand, the steps executed by the scanning device 102 are realized by the CPU 131 that loads a program read out from the ROM 132 or the external storage device 139 into the RAM 133 and executes the loaded program. Note that the scan process in FIG. 16 is executed assuming the case where the software configuration of the scan system is the configuration shown in FIG. 2B.

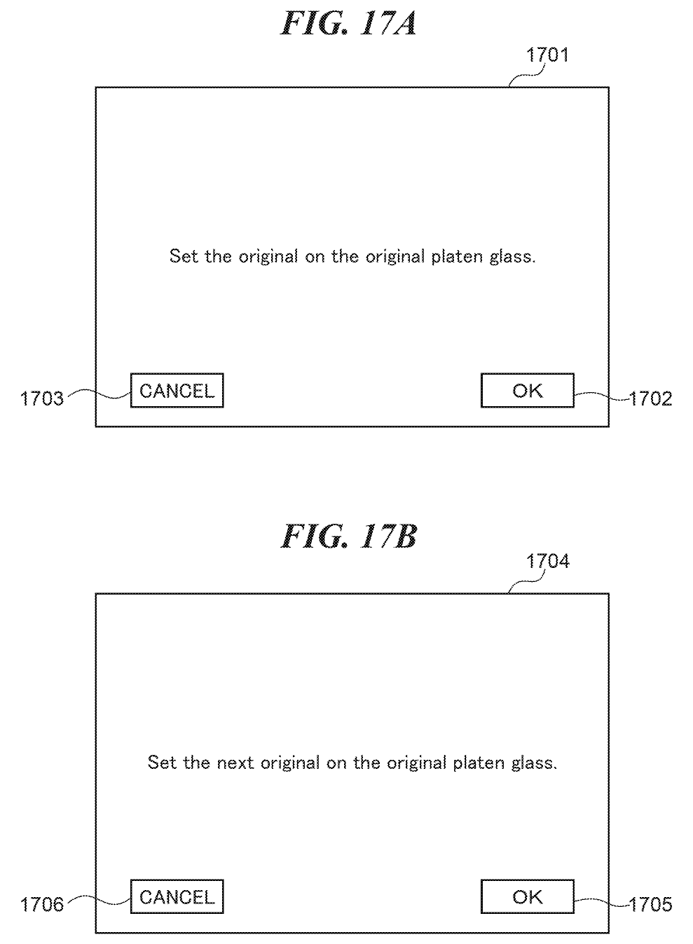

The description of the sequence in FIG. 16 will be given of processing operations executed in a step S1601 to the step S717 which are different from the first embodiment. In the step S1601, the CPU 111 of the host computer 101 controls the extension application 204 to provide a notification for prompting the user to place an original on the original platen glass of the scanning device 102. At this time, for example, as shown in FIG. 17A, the extension application 204 displays a UI screen 1701 on which a message of “Set the original on the original platen glass.” is displayed, on the display section 120. With this, the user sets this license on the original platen glass of the scanning device 102 by setting the front surface 1104 of a license in a face-down state. After that, when an OK button 1702 on the UI screen 1701 is selected by using e.g. the pointing device 119, the process proceeds to the step S715. Note that when a cancel button 1703 on the UI screen 1701 is selected by using e.g. the pointing device 119, the scan process in FIG. 16 is terminated.

In the step S715, the CPU 111 controls the extension application 204 to transmit the commands for instructing scan and image processing to the scanning device 102. This notifies the scanning device 102 of execution of original reading. In the step S716, the CPU 131 of the scanning device 102 executes original reading. With this, the front surface 1104 of the license placed on the original platen glass of the scanning device 102 is scanned. In the step S1602, the CPU 131 notifies the extension application 204 of the host computer 101 of termination of scanning.

In the step S1603, the CPU 111 of the host computer 101 controls the extension application 204 to provide a notification for prompting the user to set a next original on the original platen glass of the scanning device 102. At this time, for example, as shown in FIG. 17B, the extension application 204 displays a UI screen 1704 (second screen) displaying a message of “Set the next original on the original platen glass.”, on the display section 120. With this, the user sets the license on the original platen glass of the scanning device 102 by setting the reverse surface 1105 of the license in a face-down state. After that, when an OK button 1705 on the UI screen 1704 is selected by using e.g. the pointing device 119, the process proceeds to the step S1604. Note that when a cancel button 1706 on the UI screen 1704 is selected by using e.g. the pointing device 119, the scan process in FIG. 16 is terminated.

In the step S1604, the CPU 111 controls the extension application 204 to provide a scan instruction to the scanning device 102. This notifies the scanning device 102 of execution of original reading and image processing including the 2-in-1 processing. In the step S1605, the CPU 131 of the scanning device 102 executes original reading. With this, the reverse surface 1105 of the license placed on the original platen glass of the scanning device 102 is scanned.

In the step S717, the CPU 131 executes image processing. With this, the images of the front surface 1104 and the reverse surface 1105 of the license, which have been acquired by original reading in the steps S716 and S1605, respectively, are laid out such that they are accommodated in one page in the same size as the license, as indicated by the reference numeral 1106 in FIG. 11-5. Further, the CPU 131 performs processing for converting the image data subjected to the image processing to image data for transmission (image processing, such as compression processing, resolution conversion, and format conversion). With this, the image data for transmission is generated. Thus, the description of the scan process executed after the scan application 201 receives the scan setting is terminated.

In the third embodiment, the description has been given of the case where scanning of an original in the license mode is performed not on the feeder of the scanning device 102 but on the original platen glass of the scanning device 102. However, it is possible to cause the scanning device 102 to read an original on the original platen glass of the scanning device 102 by executing the same editing process and scan process as in the first and second embodiments, even in a case where the N-in-1 processing (including the carrier sheet mode), described in the first and second embodiments, is performed. That is, the extension application 204 of the host computer 101 can perform the N-in-1 processing even in a case where an original is scanned on the original platen glass of the scanning device 102.

In the first to third embodiments, the N-in-1 processing (including the carrier sheet mode and the license mode) has been described. Further, in the third embodiment, it is also possible to describe division processing for dividing an image of one page, which has been acquired by one operation of reading an original using the general-purpose scan software 202, into images on a plurality of pages, by using the scan process (except part of the process) of the third embodiment. This division processing can be referred to as 1-to-N processing for dividing an image of one page, acquired by one operation of reading an original using the general-purpose scan software 202, into images of N pages. Note that a value of N in the 1-to-N processing can be set to two or more pages by the user, similar to the value of N in the above-described N-in-1 processing. Here, multi-crop processing will be described as an example of the 1-to-N processing.

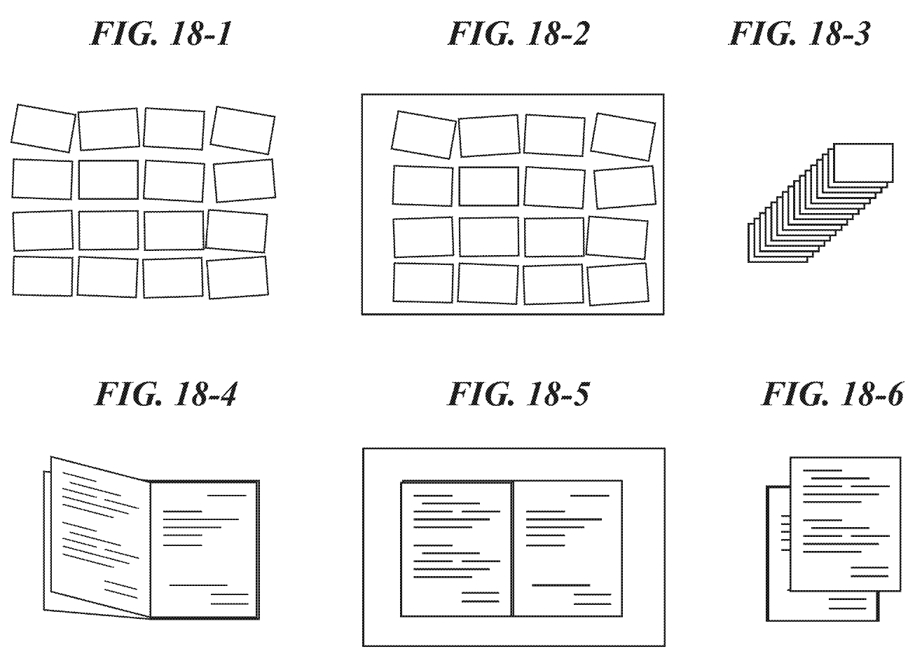

In the multi-crop processing, for example, as shown in FIG. 18-1, when a plurality of business cards are placed on the original platen glass of the scanning device 102, an image of one page is acquired by one operation of reading the original, as shown in FIG. 18-2. Further, the acquired image of one page is divided into images of the plurality of business cards, respectively, as shown in FIG. 18-3. However, to cause the scanning device 102 to execute the multi-crop processing as shown in FIGS. 18-1 to 18-3, the user is required to set a business card/invoice mode. Note that an original for which the business card/invoice mode is conveniently used is not limited to the business card, but it can be, for example, an invoice, a receipt, a contact card, or a tag sheet.

Further, in the multi-crop processing, for example, when a book in a spread state as shown in FIG. 18-4 is placed on the original platen glass of the scanning device 102 in a face-down state, an image of one page is acquired by one operation of reading the original with respect to the book in the spread state, as shown in FIG. 18-5. Further, the acquired image of one page is divided into images of right and left pages of the book in the spread state, as shown in FIG. 18-6. However, to cause the scanning device 102 to execute the multi-crop processing as shown in FIGS. 18-4 to 18-6, the user is required to set a book mode.

To set the business card/invoice mode or the book mode, first, the CPU 111 of the host computer 101 displays a detailed setting screen shown in FIG. 3E on the display section 120 in place of the detailed setting screen shown in FIG. 3C. The detailed setting screen shown in FIG. 3E is a UI screen (third screen) generated by adding not only the control item 308 and the list 312, but also control items 320 to 322 and lists 323 to 325 to the detailed setting screen shown in FIG. 3B. With this, the user can make settings related to the division processing on the detailed setting screen shown in FIG. 3E.

The control item 320 enables the user to set whether or not to perform the multi-crop processing, and FIG. 3E shows a state in which “off” is set. When the control item 320 is selected by using e.g. the pointing device 119, setting items which can be set by the control item 320 are indicated by the list 323. The list 323 indicates that the setting items which can be set by the control item 320 include not only “off”, currently set, but also “on”. Therefore, to cause the scanning device 102 to execute the multi-crop processing, the user sets “multi-crop processing: on” by using the control item 320 and the list 323 on the detailed setting screen shown in FIG. 3E.

The control item 321 enables the user to set whether or not to set the business card/invoice mode, and FIG. 3E shows a state in which “off” is set. When the control item 321 is selected by using e.g. the pointing device 119, setting items which can be set by the control item 321 are indicated by the list 324. The list 324 indicates that the setting items which can be set by the control item 321 include not only “off”, currently set, but also “on”. Therefore, to cause the scanning device 102 to execute the multi-crop processing in the business card/invoice mode, the user sets “business card/invoice mode: on” by using the control item 321 and the list 324 on the detailed setting screen shown in FIG. 3E.

The control item 322 enables the user to set whether or not to set the book mode, and FIG. 3E shows a state in which “off” is set. When the control item 322 is selected by using e.g. the pointing device 119, setting items which can be set by the control item 322 are indicated by the list 325. The list 325 indicates that the setting items which can be set by the control item 322 include not only “off”, currently set, but also “on”. Therefore, to cause the scanning device 102 to execute the multi-crop processing in the book mode, the user sets “book mode: on” by using the control item 322 and the list 325 on the detailed setting screen shown in FIG. 3E.

Note that the multi-crop processing can be executed by executing the scan process in FIG. 16 (except the steps S1602 to S1605), described in the third embodiment, in both of the business card/invoice mode and the book mode.

Further, the extension application 204 of the host computer 101 can perform the following control with respect to the 1-to-N processing, similar to the above-described N-in-1 processing: If the scanning device 102 supports the 1-to-N processing, the extension application 204 causes the scanning device 102 to perform the 1-to-N processing according to the settings related to the division processing. Alternatively, if the scanning device 102 does not support the 1-to-N processing, the extension application 204 causes the CPU 111 of the host computer 101 to perform the 1-to-N processing according to the settings related to the division processing.

Thus, the extension application 204 can cause the scanning device 102 or the CPU 111 of the host computer 101 to perform the 1-to-N processing according to whether or not the scanning device 102 supports the 1-to-N processing. Note that the extension application 204 can cause the CPU 111 of the host computer 101 to perform the 1-to-N processing according to the settings related to the division processing regardless of whether or not the scanning device 102 supports the 1-to-N processing.

According to the present disclosure, it is possible to lay out respective images on a plurality of pages, acquired by reading originals by using the standard driver, into one page.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-017797, filed February 5, 2025, which is hereby incorporated by reference herein in its entirety.

What is claimed is:

1. A non-transitory computer-readable storage medium storing an application program causing a computer to execute a method, the method comprising:
supporting a standard driver provided from a provider of an operating system; and
displaying a screen for receiving settings related to layout processing for laying out, in one page, respective images on a plurality of pages, which have been acquired by causing an image processing apparatus to read originals by using the standard driver.

2. The non-transitory computer-readable storage medium according to claim 1, wherein the method further includes controlling display of control items for receiving settings related to the layout processing on the screen based on information received from the image processing apparatus.

3. The non-transitory computer-readable storage medium according to claim 1, wherein the settings related to the layout processing include a reading size, a size after laying out the images, and a direction after laying out the images.

4. The non-transitory computer-readable storage medium according to claim 1, wherein the plurality of pages in the layout processing are two or more pages.

5. The non-transitory computer-readable storage medium according to claim 1, wherein the method further includes receiving a setting of a carrier sheet mode for laying out images of two pages, which are respective images on both surfaces of an original set within a transparent sheet to be fed by a feeder of the image processing apparatus, in one page, as one of the settings related to the layout processing via the screen.

6. The non-transitory computer-readable storage medium according to claim 1, wherein the method further includes receiving a setting of a license mode for laying out images of two pages, which are respective images on both surfaces of a license placed on an original platen glass of the image processing apparatus, in one page in the same size as the license, as one of the settings related to the layout processing via the screen.

7. The non-transitory computer-readable storage medium according to claim 1, wherein the method further includes performing the layout processing according to the settings related to the layout processing by using the image processing apparatus.

8. The non-transitory computer-readable storage medium according to claim 1, wherein the method further includes performing the layout processing according to the settings related to the layout processing.

9. The non-transitory computer-readable storage medium according to claim 1, wherein the method further includes performing the layout processing according to the settings related to the layout processing by the image processing apparatus or the computer based on the information received from the image processing apparatus.

10. The non-transitory computer-readable storage medium according to claim 1, wherein the method further includes displaying a second screen for notifying a user that the following original is to be read by the image processing apparatus, in response to a reading termination notification received from the image processing apparatus executing reading of the originals by using the standard driver.

11. The non-transitory computer-readable storage medium according to claim 1, wherein the method further includes displaying a third screen for receiving settings related to division processing for dividing an image of one page, acquired by causing the image processing apparatus to read an original by using the standard driver, into images on a plurality of pages.

12. The non-transitory computer-readable storage medium according to claim 11, wherein the method further includes controlling display of control items for receiving the settings related to the division processing on the third screen, based on the information received from the image processing apparatus.

13. The non-transitory computer-readable storage medium according to claim 11, wherein the plurality of pages in the division processing are two or more pages.

14. The non-transitory computer-readable storage medium according to claim 11, wherein the method further includes receiving a setting of a business card/invoice mode for dividing an image of one page including a plurality of business cards/invoices placed on the original platen glass of the image processing apparatus into images on a plurality of pages corresponding in number to the plurality of business cards/invoices, via the third screen, as one of the settings related to the division processing.

15. The non-transitory computer-readable storage medium according to claim 11, wherein the method further includes receiving a setting of a book mode for dividing an image of one page including right and left pages of a book in a spread state, placed on the original platen glass of the image processing apparatus, into images of two pages corresponding to the right and left pages of the book in the spread state, via the third screen, as one of the settings related to the division processing.

16. The non-transitory computer-readable storage medium according to claim 11, wherein the method further includes performing the division processing according to the settings related to the division processing by using the image processing apparatus.

17. The non-transitory computer-readable storage medium according to claim 11, wherein the method further includes performing the division processing according to the settings related to the division processing.

18. The non-transitory computer-readable storage medium according to claim 11, wherein the method further includes performing the division processing according to the settings related to the division processing based on the information received from the image processing apparatus by using the image processing apparatus or the computer.

19. A method performed by an information processing apparatus that executes an application program supporting a standard driver provided from a provider of an operating system, comprising:
causing the application program to display a screen for receiving settings related to layout processing for laying out respective images on a plurality of pages in one page, which have been acquired by causing an image processing apparatus to read originals by using the standard driver.

20. An information processing apparatus that executes an application program supporting a standard driver provided from a provider of an operating system, comprising:
a display unit configured to display a screen for receiving settings related to layout processing for laying out respective images on a plurality of pages, which have been acquired by causing an image processing apparatus to read originals by using the standard driver, in one page.
